(19) United States
(12) Patent Application Publication
(10) Pub. No.: US 2026/0093937 A1
(43) Pub. Date: Apr. 2, 2026

(54) WIDE AREA NETWORK (WAN) CALL AND DELAY-SENSITIVE HIGH PRIORITY SERVICE CONCURRENCY MANAGEMENT

(71) Applicant: QUALCOMM Incorporated, San Diego, CA (US)

(72) Inventors: Rishav REJ, Pleasanton, CA (US); Venkatraman RAJAGOPALAN, San Diego, CA (US); Qingxin CHEN, San Diego, CA (US); Sheng-Yuan TU, San Diego, CA (US); Kiran PATIL, San Diego, CA (US); Bhupesh Manoharlal UMATT, San Diego, CA (US); Joseph Patrick BURKE, Carlsbad, CA (US); Uttam PATTANAYAK, San Diego, CA (US); Scott HOOVER, Del Mar, CA (US); Jayesh BATHIJA, San Diego, CA (US)

(21) Appl. No.: 19/344,344

(22) Filed: Sep. 29, 2025

Related U.S. Application Data
(60) Provisional application No. 63/701,540, filed on Sep. 30, 2024.

(51) Int. Cl. G06K 7/10; G06K 19/077; H02J 50/00; H04W 76/28

(52) U.S. Cl. CPC G06K 7/10227; G06K 19/07758; H04W 76/28; H02J 50/001

(57) ABSTRACT

Systems and techniques are provided for wireless communications. For example, a method involves configuring a first antenna and a second antenna to communicate Wireless Wide Area Network (WWAN) signals. The method further involves establishing a WWAN session with a network entity. The method further involves, during a first period of time, cause the first antenna to communicate one or more first WWAN signals with the network entity. The method further involves reconfiguring the first antenna to communicate Radio Frequency Identification (RFID) signals. The method further involves, during a second period of time, cause the first antenna to emit an RFID communication and cause the second antenna to communicate one or more second WWAN signals with the network entity.

### CROSS-REFERENCE TO RELATED APPLICATION

This application claims the benefit of, and priority to, U.S. Provisional Application No. 63/701,540, filed Sep. 30, 2024, which is hereby incorporated by reference, in its entirety and for all purposes.

### FIELD

Aspects of the present disclosure generally relate to wireless communication. For example, aspects of the present disclosure relate to wireless communication systems and devices capable of concurrent Wireless Wide Area Network (WWAN) and Radio Frequency Identification (RFID) communications.

### INTRODUCTION

Wireless communications systems are deployed to provide various telecommunication services, including telephony, video, data, messaging, broadcasts, among others. Wireless communications systems have developed through various generations, including a first-generation analog wireless phone service (1G), a second-generation (2G) digital wireless phone service (including interim 2.5G networks), a third-generation (3G) high speed data, Internet-capable wireless service, a fourth-generation (4G) service (e.g., Long-Term Evolution (LTE), WiMax), and a fifth-generation (5G) service (e.g., New Radio (NR)).

Additional examples of wireless systems include RFID systems. In an RFID system, a device (a reader) may transmit wireless signals such as continuous wave (CW) signals to one or more RFID tags, which may be referred to as energy harvesting devices. One or more tags can receive the transmitted energy and, in turn, transmit back signals to the device.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

Disclosed are systems, methods, apparatuses, and computer-readable media for performing wireless communication. In some aspects, an apparatus for wireless communications is provided. The apparatus includes at least one memory and at least one processor coupled to the at least one memory, the at least one processor configured to: configure an antenna to communicate WWAN signals; establish a WWAN session with a network entity; during a first period of time corresponding to a Connected Mode Discontinuous Reception (CDRX) active state of the WWAN session, cause the antenna to communicate one or more WWAN signals; reconfigure the antenna to communicate RFID signals; and during a second period of time corresponding to a CDRX inactive state of the WWAN session, cause the antenna to transmit RFID communications.

In some aspects, an apparatus for wireless communications is provided. The apparatus includes at least one memory and at least one processor coupled to the at least one memory, the at least one processor configured to: configure a first antenna and a second antenna to communicate WWAN signals; establish a WWAN session with a network entity; during a first period of time corresponding to one or more first slots of a WWAN frame, cause the first antenna to communicate one or more first WWAN signals with the network entity; reconfigure the first antenna to communicate RFID signals; and during a second period of time corresponding to one or more second slots of the WWAN frame, cause the first antenna to emit an RFID communication and cause the second antenna to communicate one or more second WWAN signals with the network entity.

In some aspects, an apparatus for wireless communications is provided. The apparatus includes at least one memory and at least one processor coupled to the at least one memory, the at least one processor configured to: configure a first antenna and a second antenna to communicate WWAN signals; establish a WWAN session with a network entity; and during a first period of time of the WWAN session, cause the first antenna to communicate first WWAN data from the network entity, cause the second antenna to communicate second WWAN data to the network entity, reconfigure the second antenna to communicate RFID signals, and cause the second antenna to emit an RFID signal.

In some aspects, an apparatus for wireless communications is provided. The apparatus includes at least one memory and at least one processor coupled to the at least one memory, the at least one processor configured to: configure a first antenna to communicate WWAN signals; establish an active WWAN call with a network entity; cause the first antenna to communicate first WWAN data with the network entity; cause the active WWAN call to be in a hold state; reconfigure the first antenna to communicate RFID signals; cause the first antenna to emit an RFID communication; reconfigure the first antenna to communicate WWAN signals; and cause the first antenna to transmit a silent voice packet to the network entity.

In some aspects, a method is provided. The method includes: configuring an antenna to communicate WWAN signals; establishing a WWAN session with a network entity; during a first period of time corresponding to a CDRX active state of the WWAN session, causing the antenna to communicate one or more WWAN signals; reconfiguring the antenna to communicate RFID signals; and during a second period of time corresponding to a CDRX inactive state of the WWAN session, causing the antenna to transmit RFID communications.

In some aspects, a method is provided. The method includes: configuring a first antenna and a second antenna to communicate WWAN signals; establishing a WWAN session with a network entity; during a first period of time corresponding to one or more first slots of a WWAN frame, causing the first antenna to communicate one or more first WWAN signals with the network entity; reconfiguring the first antenna to communicate RFID signals; and during a second period of time corresponding to one or more second slots of the WWAN frame, causing the first antenna to emit an RFID communication and causing the second antenna to communicate one or more second WWAN signals with the network entity.

In some aspects, a method is provided. The method includes: configuring a first antenna and a second antenna to communicate WWAN signals; establishing a WWAN session with a network entity; and during a first period of time of the WWAN session, causing the first antenna to communicate first WWAN data from the network entity, causing the second antenna to communicate second WWAN data to the network entity, reconfiguring the second antenna to communicate RFID signals, and causing the second antenna to emit an RFID communication.

In some aspects, a non-transitory computer-readable medium is provided that has stored thereon instructions that, when executed by one or more processors, cause the one or more processors to: configure an antenna to communicate WWAN signals; establish a WWAN session with a network entity; during a first period of time corresponding to a CDRX active state of the WWAN session, cause the antenna to communicate one or more WWAN signals; reconfigure the antenna to communicate RFID signals; and during a second period of time corresponding to a CDRX inactive state of the WWAN session, cause the antenna to transmit RFID communications.

In some aspects, a non-transitory computer-readable medium is provided that has stored thereon instructions that, when executed by one or more processors, cause the one or more processors to: configure a first antenna and a second antenna to communicate WWAN signals; establish a WWAN session with a network entity; during a first period of time corresponding to one or more first slots of a WWAN frame, cause the first antenna to communicate one or more first WWAN signals with the network entity; reconfigure the first antenna to communicate RFID signals; and during a second period of time corresponding to one or more second slots of the WWAN frame, cause the first antenna to emit an RFID communication and cause the second antenna to communicate one or more second WWAN signals with the network entity.

In some aspects, a non-transitory computer-readable medium is provided that has stored thereon instructions that, when executed by one or more processors, cause the one or more processors to: configure a first antenna and a second antenna to communicate WWAN signals; establish a WWAN session with a network entity; and during a first time slot of the WWAN session, cause the first antenna to download first WWAN data from the network entity, cause the second antenna to upload second WWAN data to the network entity, reconfigure the second antenna to communicate RFID signals, and cause the second antenna to emit an RFID communication.

In some aspects, a non-transitory computer-readable medium is provided that has stored thereon instructions that, when executed by one or more processors, cause the one or more processors to: configure a first antenna to communicate WWAN signals; establish an active WWAN call with a network entity; cause the first antenna to communicate first WWAN data with the network entity; cause the active WWAN call to be in a hold state; reconfigure the first antenna to communicate RFID signals; cause the first antenna to emit an RFID communication; reconfigure the first antenna to communicate WWAN signals; and cause the first antenna to transmit a silent voice packet to the network entity.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip implementations or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying sizes, shapes, and constitutions.

Other objects and advantages associated with the aspects disclosed herein will be apparent to those skilled in the art based on the accompanying drawings and detailed description. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

The accompanying drawings are presented to aid in the description of various aspects of the disclosure and are provided solely for illustration of the aspects and no limitation thereof.

FIG. 1 is a block diagram illustrating an example of a wireless communication network, in accordance with some examples;

FIG. 2 is a diagram illustrating a design of a base station and a User Equipment (UE) device that enable transmission and processing of signals exchanged between the UE and the base station, in accordance with some examples;

FIG. 3 is a diagram illustrating an example of a disaggregated base station, in accordance with some examples;

FIG. 4 is a block diagram illustrating components of a user equipment (UE), in accordance with some examples;

FIG. 5 is a diagram illustrating an example of a radio frequency (RF) energy harvesting device, in accordance with some examples;

FIG. 6 is a diagram illustrating an example of a small signal rectification operation that may be associated with performing energy harvesting, in accordance with some examples;

FIG. 7A is a diagram illustrating example energy harvesting characteristics between input power and harvested power, in accordance with some examples;

FIG. 7B is a diagram illustrating an example of energy conversion efficiency associated with different frequencies and input powers, in accordance with some examples;

FIG. 8 is a diagram illustrating an example of a radio frequency identification (RFID) inventory sequence, in accordance with some examples;

FIG. 9 is a diagram illustrating an example of a radio frequency identification (RFID) tones, in accordance with some examples;

FIGS. 10A and 10B illustrate a communication system that may implement discontinuous reception (DRX), in accordance with some examples;

FIG. 11 is a diagram illustrating an example of combined WWAN and RFID communication, in accordance with some examples;

FIG. 12 is a flowchart diagram illustrating an example of a process for wireless communications;

FIG. 13 is a diagram illustrating an example of combined WWAN and RFID communication in an antenna-constrained scenario, in accordance with some examples;

FIG. 14 is a diagram illustrating an example of combined WWAN and RFID communication in a computationally constrained scenario, in accordance with some examples;

FIG. 15 is a flowchart diagram illustrating an example of a process for wireless communications;

FIG. 16 is a diagram illustrating an example of combined WWAN and RFID communication, in accordance with some examples;

FIG. 17 is a flowchart diagram illustrating an example of a process for wireless communications;

FIG. 18 is a diagram illustrating an example of combined WWAN and RFID communication, in accordance with some examples;

FIG. 19 is a flowchart diagram illustrating an example of a process for wireless communications; and

FIG. 20 is a diagram illustrating an example of a system for implementing certain aspects of the present technology.

### DETAILED DESCRIPTION

Certain aspects of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects described herein may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the scope of the application as set forth in the appended claims.

Wireless communication networks can be deployed to provide various communication services, such as voice, video, packet data, messaging, broadcast, any combination thereof, or other communication services. As explained herein, in some cases, wireless devices, such as mobile devices (e.g., handsets), may be utilized to simultaneously communicate with a wireless network and to concurrently interact with Internet-of-Things (IoT) devices. As further explained herein, such dual communication service and IoT functionality may be implemented within a single device or chipset, reusing antennas and/or compute capabilities, thereby lowering complexity, part cost, and power consumption.

A wireless communication network may support both access links and sidelinks for communication between wireless devices. An access link may refer to any communication link between a client device (e.g., a user equipment (UE), a station (STA), or other client device) and a base station (e.g., a Third Generation Partnership Project (3GPP) gNodeB (gNB) for 5G/NR, a 3GPP eNodeB (eNB) for 4G/LTE, a Wi-Fi access point (AP), or other base station). For example, an access link may support uplink signaling, downlink signaling, connection procedures, etc. An example of an access link is a Universal Mobile Telecommunications System (UMTS) air interface (Uu) link or interface (also referred to as an NR-Uu) between a 3GPP gNB and a UE.

In various wireless communication networks, various client devices can be utilized that may be associated with different signaling and communication needs. For example, as 5G networks expand into industrial verticals and the quantity of deployed Internet-of-Things (IoT) devices grows, network service categories, such as enhanced Mobile Broadband (eMBB), Ultra Reliable Low Latency Communications (URLLC), and massive Machine Type Communications (mMTC), etc., may be expanded to better support various IoT devices, which can include passive IoT devices, semi-passive IoT devices, etc. In some aspects, passive IoT devices may also be referred to as “ambient IoT devices.” For example, an ambient IoT device may be an IoT device that can perform ambient energy harvesting. An ambient IoT device may also be referred to as an ambient energy harvesting device. As used herein, the term “ambient IoT devices” may refer to active IoT devices, passive IoT devices, and/or semi-passive IoT devices.

According to at least one illustrative example, a wireless device (e.g., a UE) can configure a first antenna and a second antenna to communicate Wireless Wide Area Network (WWAN) signals. As used herein, “configuring an antenna” or “reconfiguring an antenna” includes adjusting or tuning the receive and/or transmit chains through which a baseband signal is translated from or to a signal compatible with the antenna, and/or includes programming additional functionality, such as impedance and/or antenna aperture tuners to align the antenna to a frequency band of interest. The wireless device can establish a WWAN session with a network entity (e.g., a base station or a portion of a base station, such as a central unit (CU), a distributed unit (DU), a radio unit (RU), a Near-Real Time (Near-RT) RAN Intelligent Controller (RIC), or a Non-Real Time (Non-RT) RIC of a disaggregated base station). During a first period of time, the wireless device can cause the first antenna to communicate one or more first WWAN signals with the network entity. The wireless device can reconfigure the first antenna to communicate Radio Frequency Identification (RFID) signals, such as for energizing and/or transmitting information to one or more RFID-based IoT devices (e.g., one or more RFID tags or other IoT devices). During a second period of time, the wireless device can cause the first antenna to emit an RFID inventory sequence and can cause the second antenna to communicate one or more second WWAN signals with the network entity.

Further aspects of the systems and techniques will be described with respect to the figures.

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

As used herein, the terms “user equipment” (UE) and “network entity” are not intended to be specific or otherwise limited to any particular radio access technology (RAT), unless otherwise noted. In general, a UE may be any wireless communication device (e.g., a mobile phone, router, tablet computer, laptop computer, and/or tracking device, etc.), wearable (e.g., smartwatch, smart-glasses, wearable ring, and/or an extended reality (XR) device such as a virtual reality (VR) headset, an augmented reality (AR) headset or glasses, or a mixed reality (MR) headset), vehicle (e.g., automobile, motorcycle, bicycle, etc.), aircraft (e.g., an airplane, jet, unmanned aerial vehicle (UAV) or drone, helicopter, airship, glider, etc.), and/or Internet of Things (IoT) device, etc., used by a user to communicate over a wireless communications network. A UE may be mobile or may (e.g., at certain times) be stationary, and may communicate with a radio access network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or “UT,” a “mobile device,” a “mobile terminal,” a “mobile station,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, wireless local area network (WLAN) networks (e.g., based on IEEE 802.11 communication standards, etc.), and so on.

A network entity can be implemented in an aggregated or monolithic base station architecture, or alternatively, in a disaggregated base station architecture, and may include one or more of a central unit (CU), a distributed unit (DU), a radio unit (RU), a Near-Real Time (Near-RT) RAN Intelligent Controller (RIC), or a Non-Real Time (Non-RT) RIC. A base station (e.g., with an aggregated/monolithic base station architecture or disaggregated base station architecture) may operate according to one of several RATs in communication with UEs depending on the network in which it is deployed, and may be alternatively referred to as an access point (AP), a network node, a NodeB (NB), an evolved NodeB (eNB), a next generation eNB (ng-eNB), a New Radio (NR) Node B (also referred to as a gNB or gNodeB), etc. A base station may be used primarily to support wireless access by UEs, including supporting data, voice, and/or signaling connections for the supported UEs. In some systems, a base station may provide edge node signaling functions while in other systems it may provide additional control and/or network management functions. A communication link through which UEs can send signals to a base station is called an uplink (UL) channel (e.g., a reverse traffic channel, a reverse control channel, an access channel, etc.). A communication link through which the base station can send signals to UEs is called a downlink (DL) or forward link channel (e.g., a paging channel, a control channel, a broadcast channel, or a forward traffic channel, etc.). The term traffic channel (TCH), as used herein, can refer to either an uplink, reverse or downlink, and/or a forward traffic channel.

The term “network entity” or “base station” (e.g., with an aggregated/monolithic base station architecture or disaggregated base station architecture) may refer to a single physical transmit receive point (TRP) or to multiple physical TRPs that may or may not be co-located. For example, where the term “network entity” or “base station” refers to a single physical TRP, the physical TRP may be an antenna of the base station corresponding to a cell (or several cell sectors) of the base station. Where the term “network entity” or “base station” refers to multiple co-located physical TRPs, the physical TRPs may be an array of antennas (e.g., as in a multiple-input multiple-output (MIMO) system or where the base station employs beamforming) of the base station. Where the term “base station” refers to multiple non-co-located physical TRPs, the physical TRPs may be a distributed antenna system (DAS) (e.g., a network of spatially separated antennas connected to a common source via a transport medium) or a remote radio head (RRH) (e.g., a remote base station connected to a serving base station). Alternatively, the non-co-located physical TRPs may be the serving base station receiving the measurement report from the UE and a neighbor base station whose reference radio frequency (RF) signals (e.g., or simply “reference signals”) the UE is measuring. Because a TRP is the point from which a base station transmits and receives wireless signals, as used herein, references to transmission from or reception at a base station are to be understood as referring to a particular TRP of the base station.

In some implementations that support positioning of UEs, a network entity or base station may not support wireless access by UEs (e.g., may not support data, voice, and/or signaling connections for UEs), but may instead transmit reference signals to UEs to be measured by the UEs, and/or may receive and measure signals transmitted by the UEs. Such a base station may be referred to as a positioning beacon (e.g., when transmitting signals to UEs) and/or as a location measurement unit (e.g., when receiving and measuring signals from UEs).

As described herein, a node (which may be referred to as a node, a network node, a network entity, or a wireless node) may include, be, or be included in (e.g., be a component of) a base station (e.g., any base station described herein), a UE (e.g., any UE described herein), a network controller, an apparatus, a device, a computing system, an integrated access and backhauling (IAB) node, a distributed unit (DU), a central unit (CU), a remote/radio unit (RU) (which may also be referred to as a remote radio unit (RRU)), and/or another processing entity configured to perform any of the techniques described herein. For example, a network node may be a UE. As another example, a network node may be a base station or network entity. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE is configured to receive information from a base station also discloses that a first network node is configured to receive information from a second network node, the first network node may refer to a first UE, a first base station, a first apparatus, a first device, a first computing system, a first set of one or more one or more components, a first processing entity, or the like configured to receive the information; and the second network node may refer to a second UE, a second base station, a second apparatus, a second device, a second computing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

An RF signal comprises an electromagnetic wave of a given frequency that transports information through the space between a transmitter and a receiver. As used herein, a transmitter may transmit a single “RF signal” or multiple “RF signals” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal. As used herein, an RF signal may also be referred to as a “wireless signal” or simply a “signal” where it is clear from the context that the term “signal” refers to a wireless signal or an RF signal.

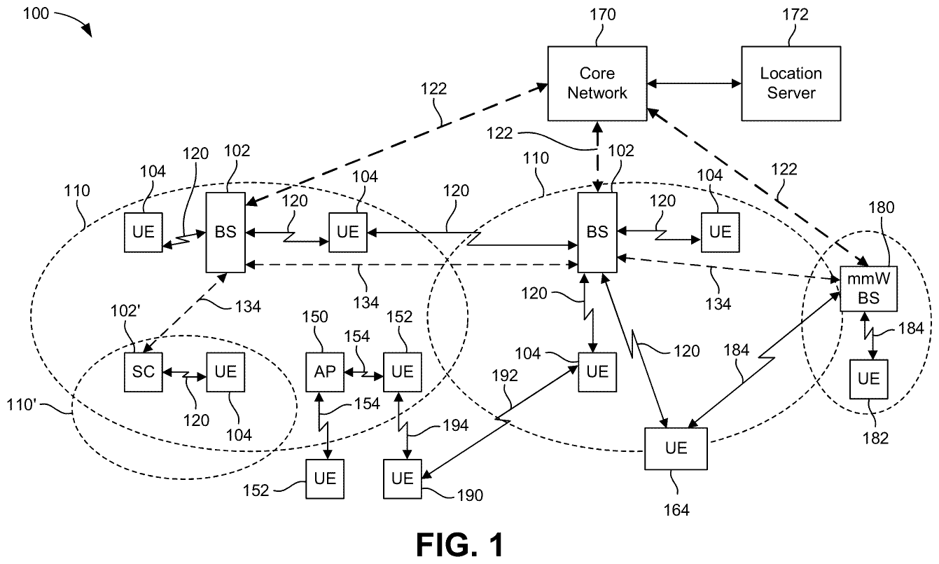

Various aspects of the systems and techniques described herein will be discussed below with respect to the figures. According to various aspects, FIG. 1 illustrates an example of a wireless communications system 100. The wireless communications system 100 (e.g., which may also be referred to as a wireless wide area network (WWAN)) can include various base stations 102 and various UEs 104. In some aspects, the base stations 102 may also be referred to as “network entities” or “network nodes.” One or more of the base stations 102 can be implemented in an aggregated or monolithic base station architecture. Additionally, or alternatively, one or more of the base stations 102 can be implemented in a disaggregated base station architecture, and may include one or more of a central unit (CU), a distributed unit (DU), a radio unit (RU), a Near-Real Time (Near-RT) RAN Intelligent Controller (RIC), or a Non-Real Time (Non-RT) RIC. The base stations 102 can include macro cell base stations (e.g., high power cellular base stations) and/or small cell base stations (e.g., low power cellular base stations). In an aspect, the macro cell base station may include eNBs and/or ng-eNBs where the wireless communications system 100 corresponds to a long-term evolution (LTE) network, or gNBs where the wireless communications system 100 corresponds to a NR network, or a combination of both, and the small cell base stations may include femtocells, picocells, microcells, etc.

The base stations 102 may collectively form a RAN and interface with a core network 170 (e.g., an evolved packet core (EPC) or a 5G core (5GC)) through backhaul links 122, and through the core network 170 to one or more location servers 172 (e.g., which may be part of core network 170 or may be external to core network 170). In addition to other functions, the base stations 102 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace, RAN information management (RIM), paging, positioning, and delivery of warning messages. The base stations 102 may communicate with each other directly or indirectly (e.g., through the EPC or 5GC) over backhaul links 134, which may be wired and/or wireless.

The base stations 102 may wirelessly communicate with the UEs 104. Each of the base stations 102 may provide communication coverage for a respective geographic coverage area 110. In an aspect, one or more cells may be supported by a base station 102 in each coverage area 110. A “cell” is a logical communication entity used for communication with a base station (e.g., over some frequency resource, referred to as a carrier frequency, component carrier, carrier, band, or the like), and may be associated with an identifier (e.g., a physical cell identifier (PCI), a virtual cell identifier (VCI), a cell global identifier (CGI)) for distinguishing cells operating via the same or a different carrier frequency. In some cases, different cells may be configured according to different protocol types (e.g., machine-type communication (MTC), narrowband IoT (NB-IoT), enhanced mobile broadband (eMBB), or others) that may provide access for different types of UEs. Because a cell is supported by a specific base station, the term “cell” may refer to either or both of the logical communication entity and the base station that supports it, depending on the context. In addition, because a TRP is typically the physical transmission point of a cell, the terms “cell” and “TRP” may be used interchangeably. In some cases, the term “cell” may also refer to a geographic coverage area of a base station (e.g., a sector), insofar as a carrier frequency can be detected and used for communication within some portion of geographic coverage areas 110.

While neighboring macro cell base station 102 geographic coverage areas 110 may partially overlap (e.g., in a handover region), some of the geographic coverage areas 110 may be substantially overlapped by a larger geographic coverage area 110. For example, a small cell base station 102′ may have a coverage area 110′ that substantially overlaps with the coverage area 110 of one or more macro cell base stations 102. A network that includes both small cell and macro cell base stations may be known as a heterogeneous network. A heterogeneous network may also include home eNBs (HeNBs), which may provide service to a restricted group known as a closed subscriber group (CSG).

The communication links 120 between the base stations 102 and the UEs 104 may include uplink (e.g., also referred to as reverse link) transmissions from a UE 104 to a base station 102 and/or downlink (e.g., also referred to as forward link) transmissions from a base station 102 to a UE 104. The communication links 120 may use MIMO antenna technology, including spatial multiplexing, beamforming, and/or transmit diversity. The communication links 120 may be provided using one or more carrier frequencies. Allocation of carriers may be asymmetric with respect to downlink and uplink (e.g., a greater or lesser quantity of carriers may be allocated for downlink than for uplink).

Beamforming, which may also be referred to as spatial filtering, directional transmission, or directional reception, is a signal processing technique that may be used at a transmitting device or a receiving device (e.g., one or more of the base stations 102, UEs 104, etc.) to shape or steer an antenna beam (e.g., a transmit beam, a receive beam) along a spatial path between the transmitting device and the receiving device. Beamforming may be implemented based on combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A transmitting device and/or a receiving device (e.g., such as one or more of base stations 102 and/or UEs 104) may use beam sweeping techniques as part of beam forming operations. For example, a base station 102 (e.g., or other transmitting device) may use multiple antennas or antenna arrays (e.g., antenna panels) to conduct beamforming operations for directional communications with a UE 104 (e.g., or other receiving device). Some signals (e.g., synchronization signals, reference signals, beam selection signals, or other control signals) may be transmitted by base station 102 (or other transmitting device) multiple times in different directions. For example, the base station 102 may transmit a signal according to different beamforming weight sets associated with different directions of transmission. Transmissions in different beam directions may be used to identify (e.g., by a transmitting device, such as a base station 102, or by a receiving device, such as a UE 104) a beam direction for later transmission or reception by the base station 102.

Some signals, such as data signals associated with a particular receiving device, may be transmitted by a base station 102 in a single beam direction (e.g., a direction associated with the receiving device, such as a UE 104). In some examples, the beam direction associated with transmissions along a single beam direction may be determined based on a signal that was transmitted in one or more beam directions. For example, a UE 104 may receive one or more of the signals transmitted by the base station 102 in different directions and may report to the base station 104 an indication of the signal that the UE 104 received with a highest signal quality or an otherwise acceptable signal quality.

In some examples, transmissions by a device (e.g., by a base station 102 or a UE 104) may be performed using multiple beam directions, and the device may use a combination of digital precoding or radio frequency beamforming to generate a combined beam for transmission (e.g., from a base station 102 to a UE 104, from a transmitting device to a receiving device, etc.). The UE 104 may report feedback that indicates precoding weights for one or more beam directions, and the feedback may correspond to a configured number of beams across a system bandwidth or one or more sub-bands. The base station 102 may transmit a reference signal (e.g., a cell-specific reference signal (CRS), a channel state information reference signal (CSI-RS), etc.), which may be precoded or unprecoded. The UE 104 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 102, a UE 104 may employ similar techniques for transmitting signals multiple times in different directions (e.g., for identifying a beam direction for subsequent transmission or reception by the UE 104) or for transmitting a signal in a single direction (e.g., for transmitting data to a receiving device).

A receiving device (e.g., a UE 104) may try multiple receive configurations (e.g., directional listening) when receiving various signals from the base station 102, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may further include a WLAN AP 150 in communication with WLAN stations (STAs) 152 via communication links 154 in an unlicensed frequency spectrum (e.g., 5 Gigahertz (GHz)). When communicating in an unlicensed frequency spectrum, the WLAN STAs 152 and/or the WLAN AP 150 may perform a clear channel assessment (CCA) or listen before talk (LBT) procedure prior to communicating in order to determine whether the channel is available. In some examples, the wireless communications system 100 can include devices (e.g., UEs, etc.) that communicate with one or more UEs 104, base stations 102, APs 150, etc., utilizing the ultra-wideband (UWB) spectrum. The UWB spectrum can range from 3.1 to 10.5 GHZ.

The small cell base station 102′ may operate in a licensed and/or an unlicensed frequency spectrum. When operating in an unlicensed frequency spectrum, the small cell base station 102′ may employ LTE or NR technology and use the same 5 GHz unlicensed frequency spectrum as used by the WLAN AP 150. The small cell base station 102′, employing LTE and/or 5G in an unlicensed frequency spectrum, may boost coverage to and/or increase capacity of the access network. NR in unlicensed spectrum may be referred to as NR-U. LTE in an unlicensed spectrum may be referred to as LTE-U, licensed assisted access (LAA), or MulteFire.

The wireless communications system 100 may further include a millimeter wave (mmW) base station 180 that may operate in mmW frequencies and/or near mmW frequencies in communication with a UE 182. The mmW base station 180 may be implemented in an aggregated or monolithic base station architecture, or alternatively, in a disaggregated base station architecture (e.g., including one or more of a CU, a DU, a RU, a Near-RT RIC, or a Non-RT RIC). Extremely high frequency (EHF) is part of the RF in the electromagnetic spectrum. EHF has a range of 30 GHz to 300 GHz and a wavelength between 1 millimeter and 10 millimeters. Radio waves in this band may be referred to as a millimeter wave. Near mmW may extend down to a frequency of 3 GHZ with a wavelength of 100 millimeters. The super high frequency (SHF) band extends between 3 GHz and 30 GHz, also referred to as centimeter wave. Communications using the mmW and/or near mmW radio frequency band have high path loss and a relatively short range. The mmW base station 180 and the UE 182 may utilize beamforming (e.g., transmit and/or receive) over an mmW communication link 184 to compensate for the extremely high path loss and short range. Further, it will be appreciated that in alternative configurations, one or more base stations 102 may also transmit using mmW or near mmW and beamforming. Accordingly, it will be appreciated that the foregoing illustrations are merely examples and should not be construed to limit the various aspects disclosed herein.

In some aspects relating to 5G, the frequency spectrum in which wireless network nodes or entities (e.g., base stations 102/180, UEs 104/182) operate is divided into multiple frequency ranges, FR1 (e.g., from 450 to 6,000 Megahertz (MHz)), FR2 (e.g., from 24,250 to 52,600 MHz), FR3 (e.g., above 52,600 MHz), and FR4 (e.g., between FR1 and FR2). In a multi-carrier system, such as 5G, one of the carrier frequencies is referred to as the “primary carrier” or “anchor carrier” or “primary serving cell” or “PCell,” and the remaining carrier frequencies are referred to as “secondary carriers” or “secondary serving cells” or “SCells.” In carrier aggregation, the anchor carrier is the carrier operating on the primary frequency (e.g., FR1) utilized by a UE 104/182 and the cell in which the UE 104/182 either performs the initial radio resource control (RRC) connection establishment procedure or initiates the RRC connection re-establishment procedure. The primary carrier carries all common and UE-specific control channels and may be a carrier in a licensed frequency (however, this is not always the case). A secondary carrier is a carrier operating on a second frequency (e.g., FR2) that may be configured once the RRC connection is established between the UE 104 and the anchor carrier and that may be used to provide additional radio resources. In some cases, the secondary carrier may be a carrier in an unlicensed frequency. The secondary carrier may contain only necessary signaling information and signals, for example, those that are UE-specific may not be present in the secondary carrier, since both primary uplink and downlink carriers are typically UE-specific. This means that different UEs 104/182 in a cell may have different downlink primary carriers. The same is true for the uplink primary carriers. The network is able to change the primary carrier of any UE 104/182 at any time. This is done, for example, to balance the load on different carriers. Because a “serving cell” (e.g., whether a PCell or an SCell) corresponds to a carrier frequency and/or component carrier over which some base station is communicating, the term “cell,” “serving cell,” “component carrier,” “carrier frequency,” and the like can be used interchangeably.

For example, still referring to FIG. 1, one of the frequencies utilized by the macro cell base stations 102 may be an anchor carrier (or “PCell”) and other frequencies utilized by the macro cell base stations 102 and/or the mmW base station 180 may be secondary carriers (“SCells”). In carrier aggregation, the base stations 102 and/or the UEs 104 may use spectrum up to Y MHz (e.g., 5, 10, 15, 20, 100 MHz) bandwidth per carrier up to a total of Yx MHz (e.g., x component carriers) for transmission in each direction. The component carriers may or may not be adjacent to each other on the frequency spectrum. Allocation of carriers may be asymmetric with respect to the downlink and uplink (e.g., a greater or lesser quantity of carriers may be allocated for downlink than for uplink). The simultaneous transmission and/or reception of multiple carriers enables the UE 104/182 to significantly increase its data transmission and/or reception rates. For example, two 20 MHz aggregated carriers in a multi-carrier system would theoretically lead to a two-fold increase in data rate (e.g., 40 MHz), compared to that attained by a single 20 MHz carrier.

In order to operate on multiple carrier frequencies, a base station 102 and/or a UE 104 can be equipped with multiple receivers and/or transmitters. For example, a UE 104 may have two receivers, “Receiver 1” and “Receiver 2,” where “Receiver 1” is a multi-band receiver that can be tuned to band (e.g., carrier frequency) ‘X’ or band ‘Y,’ and “Receiver 2” is a one-band receiver tunable to band ‘Z’ only. In this example, if the UE 104 is being served in band ‘X,’ band ‘X’ would be referred to as the PCell or the active carrier frequency, and “Receiver 1” would need to tune from band ‘X’ to band ‘Y’ (e.g., an SCell) in order to measure band ‘Y’ (and vice versa). In contrast, whether the UE 104 is being served in band ‘X’ or band ‘Y,’ because of the separate “Receiver 2,” the UE 104 can measure band ‘Z’ without interrupting the service on band ‘X’ or band ‘Y.’

The wireless communications system 100 may further include a UE 164 that may communicate with a macro cell base station 102 over a communication link 120 and/or the mmW base station 180 over an mmW communication link 184. For example, the macro cell base station 102 may support a PCell and one or more SCells for the UE 164 and the mmW base station 180 may support one or more SCells for the UE 164.

The wireless communications system 100 may further include one or more UEs, such as UE 190, that connects indirectly to one or more communication networks via one or more device-to-device (D2D) peer-to-peer (P2P) links (e.g., referred to as “sidelinks”). In the example of FIG. 1, UE 190 has a D2D P2P link 192 with one of the UEs 104 connected to one of the base stations 102 (e.g., through which UE 190 may indirectly obtain cellular connectivity) and a D2D P2P link 194 with WLAN STA 152 connected to the WLAN AP 150 (e.g., through which UE 190 may indirectly obtain WLAN-based Internet connectivity). In an example, the D2D P2P links 192 and 194 may be supported with any well-known D2D RAT, such as LTE Direct (LTE-D), Wi-Fi Direct (Wi-Fi-D), Bluetooth®, and so on.

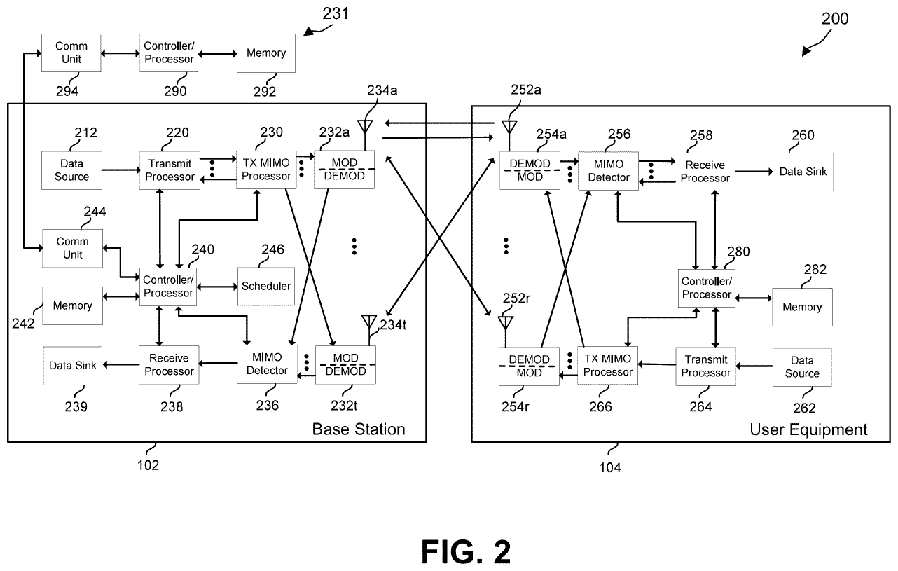

FIG. 2 illustrates a block diagram of an example architecture 200 of a base station 102 and a UE 104 that enables transmission and processing of signals exchanged between the UE and the base station. Example architecture 200 includes components of a base station 102 and a UE 104, which may be one of the base stations 102 and one of the UEs 104 illustrated in FIG. 1. Base station 102 may be equipped with T antennas 234a through 234t, and UE 104 may be equipped with R antennas 252a through 252r, where in general T≥1 and R≥1.

At base station 102, a transmit processor 220 may receive data from a data source 212 for one or more UEs, select one or more modulation and coding schemes (MCS) for each UE based on channel quality indicators (CQIs) received from the UE, process (e.g., encode and modulate) the data for each UE based on the MCS(s) selected for the UE, and provide data symbols for all UEs. Transmit processor 220 may also process system information (e.g., for semi-static resource partitioning information (SRPI) and/or the like) and control information (e.g., CQI requests, grants, upper layer signaling, and/or the like) and provide overhead symbols and control symbols. Transmit processor 220 may also generate reference symbols for reference signals (e.g., the cell-specific reference signal (CRS)) and synchronization signals (e.g., the primary synchronization signal (PSS) and secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. The modulators 232a through 232t are shown as a combined modulator-demodulator (MOD-DEMOD). In some cases, the modulators and demodulators can be separate components. Each modulator of the modulators 232a to 232t may process a respective output symbol stream (e.g., for an orthogonal frequency-division multiplexing (OFDM) scheme and/or the like) to obtain an output sample stream. Each modulator of the modulators 232a to 232t may further process (e.g., convert to analog, amplify, filter, and upconvert) the output sample stream to obtain a downlink signal. T downlink signals may be transmitted from modulators 232a to 232t via T antennas 234a through 234t, respectively. According to certain aspects described in more detail below, the synchronization signals can be generated with location encoding to convey additional information.

At UE 104, antennas 252a through 252r may receive the downlink signals from base station 102 and/or other base stations and may provide received signals to one or more demodulators (DEMODs) 254a through 254r, respectively. The demodulators 254a through 254r are shown as a combined modulator-demodulator (MOD-DEMOD). In some cases, the modulators and demodulators can be separate components. Each demodulator of the demodulators 254a through 254r may condition (e.g., filter, amplify, downconvert, and digitize) a received signal to obtain input samples. Each demodulator of the demodulators 254a through 254r may further process the input samples (e.g., for OFDM and/or the like) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 104 to a data sink 260, and provide decoded control information and system information to a controller/processor 280. A channel processor may determine reference signal received power (RSRP), received signal strength indicator (RSSI), reference signal received quality (RSRQ), channel quality indicator (CQI), and/or the like.

On the uplink, at UE 104, a transmit processor 264 may receive and process data from a data source 262 and control information (e.g., for reports comprising RSRP, RSSI, RSRQ, CQI, and/or the like) from controller/processor 280. Transmit processor 264 may also generate reference symbols for one or more reference signals (e.g., based on a beta value or a set of beta values associated with the one or more reference signals). The symbols from transmit processor 264 may be precoded by a TX-MIMO processor 266, further processed by modulators 254a through 254r (e.g., for DFT-s-OFDM, CP-OFDM, and/or the like), and transmitted to base station 102. At base station 102, the uplink signals from UE 104 and other UEs may be received by antennas 234a through 234t, processed by demodulators 232a through 232t, detected by a MIMO detector 236 (e.g., if applicable), and further processed by a receive processor 238 to obtain decoded data and control information sent by UE 104. Receive processor 238 may provide the decoded data to a data sink 239 and the decoded control information to controller (e.g., processor) 240. Base station 102 may include communication unit 244 and communicate to a network controller 231 via communication unit 244. Network controller 231 may include communication unit 294, controller/processor 290, and memory 292.

In some aspects, one or more components of UE 104 may be included in a housing. Controller 240 of base station 102, controller/processor 280 of UE 104, and/or any other component(s) of FIG. 2 may perform one or more techniques associated with implicit UCI beta value determination for NR.

Memories 242 and 282 may store data and program codes for the base station 102 and the UE 104, respectively. A scheduler 246 may schedule UEs for data transmission on the downlink, uplink, and/or sidelink.

In some aspects, deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (e.g., such as a Node B (NB), evolved NB (eNB), NR BS, 5G NB, access point (AP), a transmit receive point (TRP), or a cell, etc.) may be implemented as an aggregated base station (e.g., also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (e.g., such as one or more central or centralized units (CUs), one or more distributed units (DUs), or one or more radio units (RUS)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (e.g., such as the network configuration sponsored by the O-RAN Alliance)), or a virtualized radio access network (e.g., vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

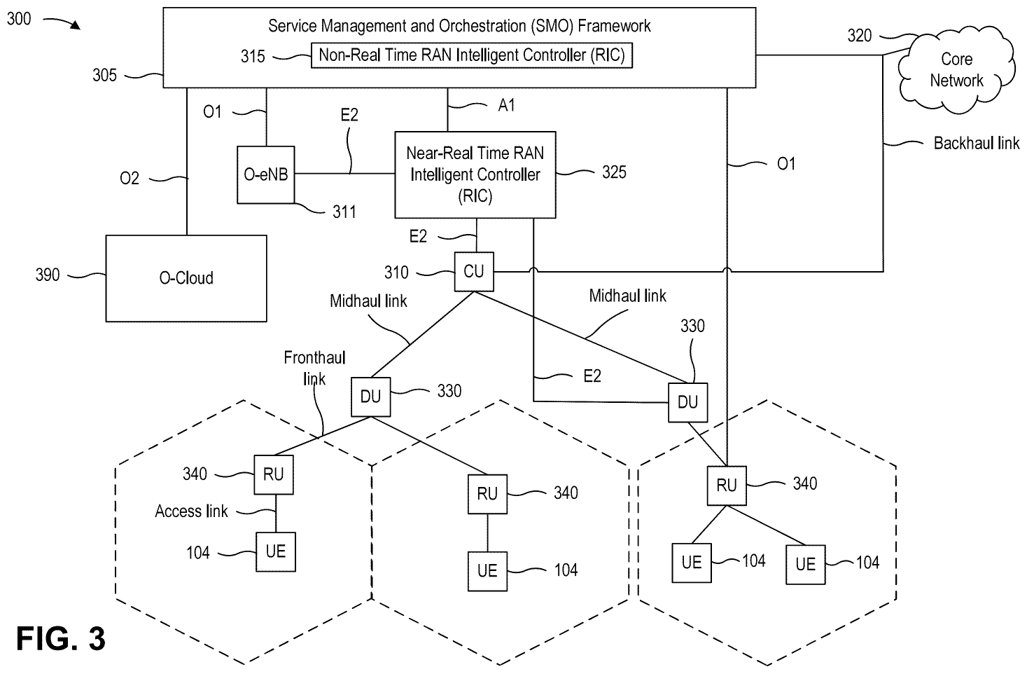

FIG. 3 is a diagram illustrating an example disaggregated base station 300 architecture. The disaggregated base station 300 architecture may include one or more central units (CUs) 310 that can communicate directly with a core network 320 via a backhaul link, or indirectly with the core network 320 through one or more disaggregated base station units (e.g., such as a Near-Real Time (Near-RT) RAN Intelligent Controller (RIC) 325 via an E2 link, or a Non-Real Time (Non-RT) RIC 315 associated with a Service Management and Orchestration (SMO) Framework 305, or both). A CU 310 may communicate with one or more distributed units (DUs) 330 via respective midhaul links, such as an F1 interface. The DUs 330 may communicate with one or more radio units (RUS) 340 via respective fronthaul links. The RUs 340 may communicate with respective UEs 104 via one or more radio frequency (RF) access links. In some implementations, the UE 104 may be simultaneously served by multiple RUs 340.

Each of the units (e.g., the CUs 310, the DUs 330, the RUs 340, as well as the Near-RT RICs 325, the Non-RT RICs 315, and the SMO Framework 305) illustrated in FIG. 3 and/or described herein may include one or more interfaces or be coupled to one or more interfaces configured to receive or transmit signals, data, or information (e.g., collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (e.g., such as a radio frequency (RF) transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (e.g., Central Unit-User Plane (CU-UP)), control plane functionality (e.g., Central Unit-Control Plane (CU-CP)), or a combination thereof. In some implementations, the CU 310 can be logically split into one or more CU-UP units and one or more CU-CP units. The CU-UP unit can communicate bidirectionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (e.g., such as modules for forward error correction (FEC) encoding and decoding, scrambling, modulation and demodulation, or the like) depending on a functional split, such as those defined by the 3rd Generation Partnership Project (3GPP). In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (e.g., such as performing fast Fourier transform (FFT), inverse FFT (IFFT), digital beamforming, physical random-access channel (PRACH) extraction and filtering, or the like), or both, based on the functional split, such as a lower layer functional split. In such an architecture, the RU(s) 340 can be implemented to handle over the air (OTA) communication with one or more UEs 104. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (e.g., such as an O1 interface). For virtualized network elements, the SMO Framework 305 may be configured to interact with a cloud computing platform (e.g., such as an open cloud (O-Cloud) 390) to perform network element life cycle management (e.g., such as to instantiate virtualized network elements) via a cloud computing platform interface (e.g., such as an O2 interface). Such virtualized network elements can include, but are not limited to, CUs 310, DUs 330, RUS 340, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (e.g., such as via an A1 interface) the Near-RT RIC 325. The Near-RT RIC 325 may be configured to include a logical function that enables near-real-time control and optimization of RAN elements and resources via data collection and actions over an interface (e.g., such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (e.g., such as reconfiguration via O1) or via creation of RAN management policies (e.g., such as A1 policies).

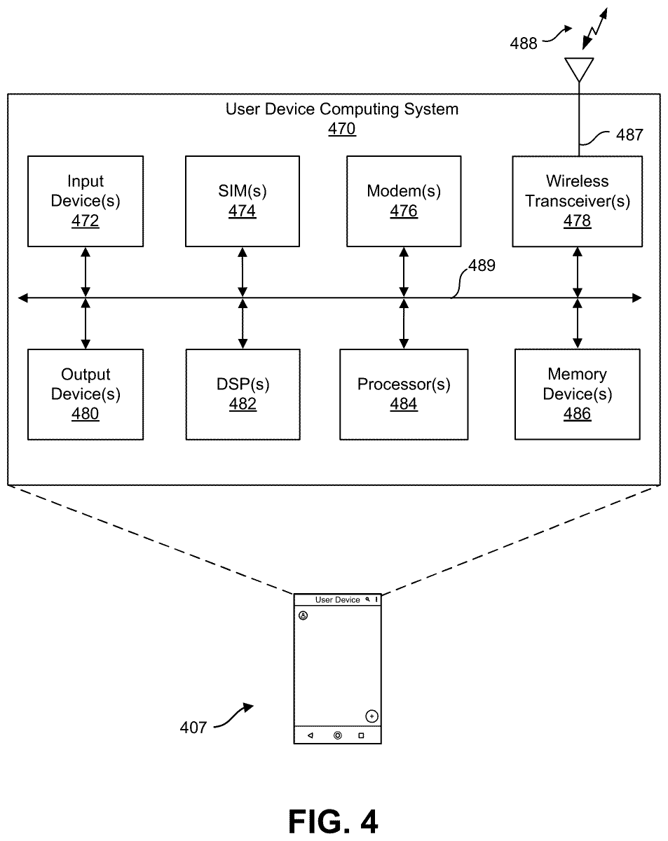

FIG. 4 illustrates an example of a computing system 470 of a wireless device 407. The wireless device 407 may include a client device such as a UE (e.g., UE 104, UE 152, UE 190) or other type of device (e.g., a station (STA) configured to communication using a Wi-Fi interface) that may be used by an end-user. For example, the wireless device 407 may include a mobile phone, router, tablet computer, laptop computer, tracking device, wearable device (e.g., a smart watch, glasses, an extended reality (XR) device such as a virtual reality (VR), augmented reality (AR), or mixed reality (MR) device, etc.), Internet of Things (IoT) device, a vehicle, an aircraft, and/or another device that is configured to communicate over a wireless communications network. The computing system 470 includes software and hardware components that may be electrically or communicatively coupled via a bus 489 (e.g., or may otherwise be in communication, as appropriate). For example, the computing system 470 includes one or more processors 484. The one or more processors 484 may include one or more CPUs, ASICs, FPGAS, APs, GPUs, VPUs, NSPs, microcontrollers, dedicated hardware, any combination thereof, and/or other processing device or system. The bus 489 may be used by the one or more processors 484 to communicate between cores and/or with the one or more memory devices 486.

The computing system 470 may also include one or more memory devices 486, one or more digital signal processors (DSPs) 482, one or more SIMs 474, one or more modems 476, one or more wireless transceivers 478, an antenna 487, one or more input devices 472 (e.g., a camera, a mouse, a keyboard, a touch sensitive screen, a touch pad, a keypad, a microphone, and/or the like), and one or more output devices 480 (e.g., a display, a speaker, a printer, and/or the like).

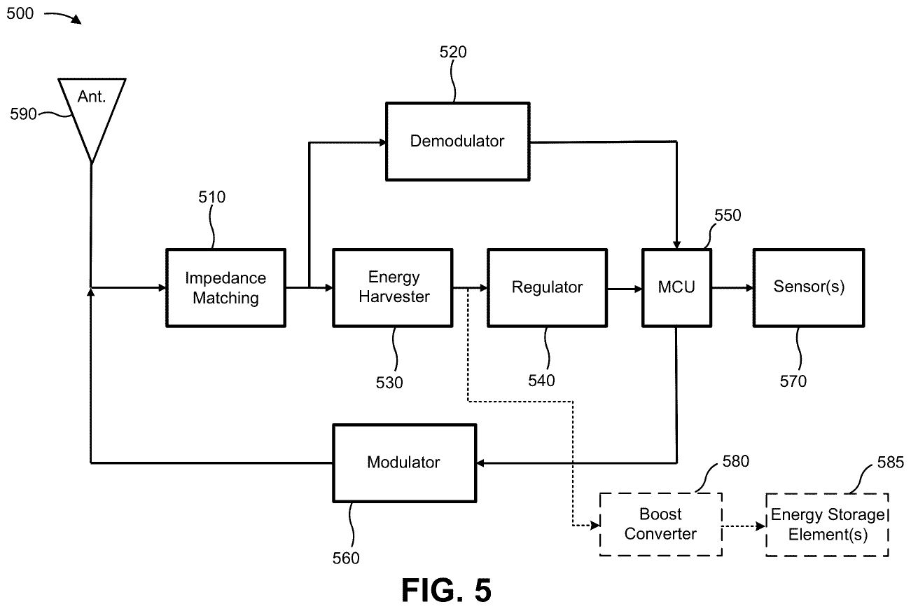

In some aspects, computing system 470 may include one or more radio frequency (RF) interfaces configured to transmit and/or receive RF signals. In some examples, an RF interface may include components such as modem(s) 476, wireless transceiver(s) 478, and/or antennas 487. The one or more wireless transceivers 478 may transmit and receive wireless signals (e.g., signal 488) via antenna 487 from one or more other devices, such as other wireless devices, network devices (e.g., base stations such as eNBs and/or gNBs, Wi-Fi access points (APs) such as routers, range extenders or the like, etc.), cloud networks, and/or the like. In some examples, the computing system 470 may include multiple antennas or an antenna array that may facilitate simultaneous transmit and receive functionality. Antenna 487 may be an omnidirectional antenna such that radio frequency (RF) signals may be received from and transmitted in all directions. The wireless signal 488 may be transmitted via a wireless network. The wireless network may be any wireless network, such as a cellular or telecommunications network (e.g., 3G, 4G, 5G, etc.), wireless local area network (e.g., a Wi-Fi network), a Bluetooth™ network, and/or other network. In some cases, the antenna may be configured to emit continuous wave communications that can stimulate energy (e.g., energize) in an energy harvesting device (e.g., an RFID tag) such as energy harvesting device 500 shown in FIG. 5. In some cases, the antenna may be configured to receive RFID communications from such an energy harvesting device.

In some examples, the wireless signal 488 may be transmitted directly to other wireless devices using sidelink communications (e.g., using a PC5 interface, using a DSRC interface, etc.). Wireless transceivers 478 may be configured to transmit RF signals for performing sidelink communications via antenna 487 in accordance with one or more transmit power parameters that may be associated with one or more regulation modes. Wireless transceivers 478 may also be configured to receive sidelink communication signals having different signal parameters from other wireless devices.

In some examples, the one or more wireless transceivers 478 may include an RF front end including one or more components, such as an amplifier, a mixer (e.g., also referred to as a signal multiplier) for signal down conversion, a frequency synthesizer (e.g., also referred to as an oscillator) that provides signals to the mixer, a baseband filter, an analog-to-digital converter (ADC), one or more power amplifiers, among other components. The RF front-end may generally handle selection and conversion of the wireless signals 488 into a baseband or intermediate frequency and may convert the RF signals to the digital domain.

In some cases, the computing system 470 may include a coding-decoding device (or CODEC) configured to encode and/or decode data transmitted and/or received using the one or more wireless transceivers 478. In some cases, the computing system 470 may include an encryption-decryption device or component configured to encrypt and/or decrypt data (e.g., according to the AES and/or DES standard) transmitted and/or received by the one or more wireless transceivers 478.

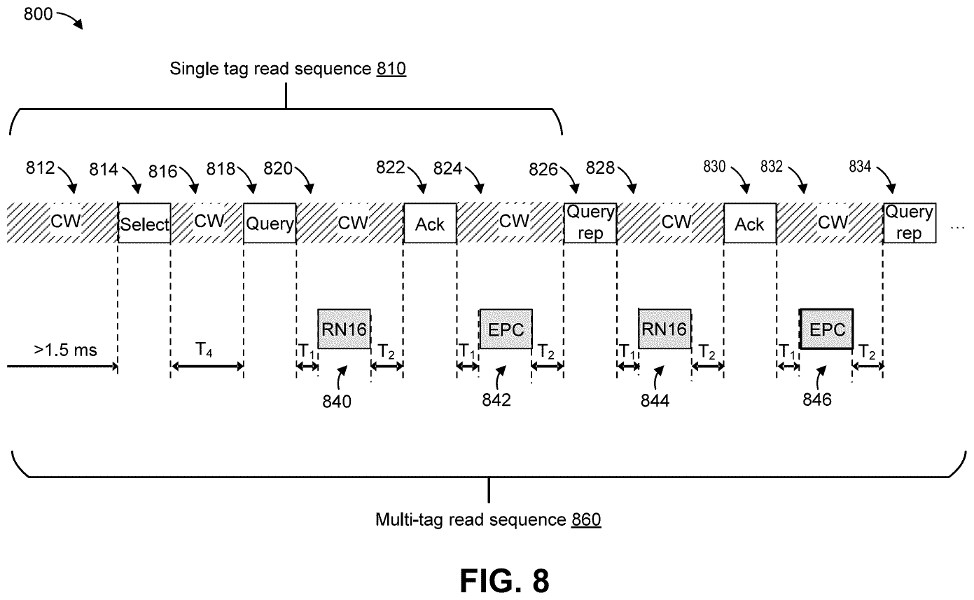

The one or more SIMs 474 may each securely store an international mobile subscriber identity (IMSI) number and related key assigned to the user of the wireless device 407. The IMSI and key may be used to identify and authenticate the subscriber when accessing a network provided by a network service provider or operator associated with the one or more SIMs 474. The one or more modems 476 may modulate one or more signals to encode information for transmission using the one or more wireless transceivers 478. The one or more modems 476 may also demodulate signals received by the one or more wireless transceivers 478 in order to decode the transmitted information. In some examples, the one or more modems 476 may include a Wi-Fi modem, a 4G (or LTE) modem, a 5G (or NR) modem, and/or other types of modems. The one or more modems 476 and the one or more wireless transceivers 478 may be used for communicating data for the one or more SIMs 474. In some examples, the one or more wireless transceivers 478 may be able to process or modulate signals such as continuous wave signals and/or receive and demodulate signals received from an RFID tag or energy harvesting device. An example of RFID signals is shown further with respect to FIG. 8.

The computing system 470 may also include (and/or be in communication with) one or more non-transitory machine-readable storage media or storage devices (e.g., one or more memory devices 486), which may include, without limitation, local and/or network accessible storage, a disk drive, a drive array, an optical storage device, a solid-state storage device such as a RAM and/or a ROM, which may be programmable, flash-updateable, and/or the like. Such storage devices may be configured to implement any appropriate data storage, including without limitation, various file systems, database structures, and/or the like.

In various aspects, functions may be stored as one or more computer-program products (e.g., instructions or code) in memory device(s) 486 and executed by the one or more processor(s) 484 and/or the one or more DSPs 482. The computing system 470 may also include software elements (e.g., located within the one or more memory devices 486), including, for example, an operating system, device drivers, executable libraries, and/or other code, such as one or more application programs, which may comprise computer programs implementing the functions provided by various aspects, and/or may be designed to implement methods and/or configure systems, as described herein.

In some examples, ambient IoT devices (e.g., active IoT devices, passive IoT devices, semi-passive IoT devices, etc.) are relatively low-cost UEs that may be used to implement one or more sensing and communication capabilities in an IoT network or deployment. In some examples, passive and/or semi-passive IoT sensors (e.g., devices) can be used to provide sensing capabilities for various processes and use cases, such as asset management, logistics, warehousing, manufacturing, etc. Passive and semi-passive IoT devices can include one or more sensors, a processor or micro-controller, and an energy harvester for generating electrical power from incident downlink radio frequency (RF) signals received at the passive or semi-passive IoT device.

Based on harvesting energy from incident downlink RF signals (e.g., transmitted by an energy source device such as a base station, gNB, etc.), ambient energy harvesting devices (e.g., ambient IoT devices) may be provided without an energy storage element and/or can be provided with a relatively small energy storage element (e.g., battery, capacitor, etc.). Ambient energy harvesting devices provided without an energy storage element may include passive IoT devices. Ambient energy harvesting devices provided with a relatively small energy storage element may include semi-passive IoT devices. Ambient energy harvesting devices that are provided with an energy storage element may include active IoT devices. Energy harvesting devices can be deployed at large scales, based on the simplification in their manufacture and deployment associated with implementing wireless energy harvesting.

In some examples, ambient energy harvesting devices can harvest energy from dedicated downlink RF signals for energy harvesting. In some cases, an ambient energy harvesting device may be configured to perform energy harvesting only for dedicated downlink RF signals for energy harvesting. In some cases, ambient energy harvesting devices can harvest energy from ambient downlink RF signals (e.g., including dedicated downlink RF signals for energy harvesting and various other downlink RF signals that are not dedicated energy harvesting signals).

In some cases, an ambient energy harvesting device can use the same antenna for energy harvesting and communications. For example, an ambient energy harvesting device can use the same antenna to perform energy harvesting and backscatter communications, where the energy harvesting and the backscatter communications are based on the same downlink RF signal. In some examples, an ambient energy harvesting device can include a first antenna used for energy harvesting and a second antenna used for communications, where the first antenna is different from the second antenna. For instance, an ambient IoT device can use the first antenna to perform energy harvesting and can use the second antenna to perform communication (e.g., transmitting and/or receiving).

The backscatter transmitter can generate and transmit an uplink signal by reflecting and backscatter modulating an incident downlink signal using the first antenna. In some examples, an ambient IoT device can use a backscatter transmitter that is the same as or similar to a backscatter transmitter utilized by a passive or semi-passive IoT device, as described above. An active transmitter can use a battery or other energy storage element included in the ambient IoT device to generate and transmit an uplink signal, using an antenna that is different from the first antenna associated with the backscatter transmitter (e.g., a second antenna). To transmit an uplink signal, the backscatter transmitter of an ambient IoT device must first receive a downlink signal that can be reflected and backscatter modulated. For example, the backscatter transmitter may be unable to transmit an uplink signal unless or until a continuous sine wave is received as a downlink signal from a base station, gNB, or other energy source device. The active transmitter of an ambient IoT device can perform uplink communication that is triggered by the ambient IoT device (e.g., without dependence on first receiving a downlink signal). In some examples, ambient IoT devices may include a small battery or energy storage element and may be unable to sustain longer periods of uplink communication using the active transmitter of the ambient IoT device. For example, active transmission by an ambient IoT device may quickly deplete the onboard battery or other energy storage element(s) included in the ambient IoT device.

FIG. 5 is a diagram illustrating an example of an architecture of a radio frequency (RF) energy harvesting device 500. As will be described in greater depth below, the RF energy harvesting device 500 can harvest RF energy from one or more RF signals received using an antenna 590. As used herein, the term “energy harvesting” may be used interchangeably with “power harvesting.” In some aspects, energy harvesting device 500 can be implemented as an Internet-of-Things (IoT) device, can be implemented as a sensor, etc., as will be described in greater depth below. In other examples, energy harvesting device 500 can be implemented as a RFID tag or various other RFID devices.

The energy harvesting device 500 includes one or more antennas 590 that can be used to transmit and receive one or more wireless signals. For example, energy harvesting device 500 can use antenna(s) 590 to receive one or more downlink signals and to transmit one or more uplink signals. An impedance matching component 510 can be used to match the impedance of antenna(s) 590 to the impedance of one or more (or all) of the receive components included in energy harvesting device 500. In some examples, the receive components of energy harvesting device 500 can include a demodulator 520 (e.g., for demodulating a received downlink signal), an energy harvester 530 (e.g., for harvesting RF energy from the received downlink signal), a regulator 540, a micro-controller unit (MCU) 550, a modulator 560 (e.g., for generating an uplink signal). In some cases, the receive components of energy harvesting device 500 may further include one or more sensors 570.

The downlink signals can be received from one or more transmitters. For example, energy harvesting device 500 may receive a downlink signal from a network node or network entity that is included in a same wireless network as the energy harvesting device 500. In some cases, the network entity can be a base station, gNB, etc., that communicates with the energy harvesting device 500 using a cellular communication network. For example, the cellular communication network can be implemented according to the 3G, 4G, 5G, and/or other cellular standard (e.g., including future standards, such as 6G and beyond).

In some cases, energy harvesting device 500 can be implemented as a passive or semi-passive energy harvesting device (e.g., an ambient energy harvesting device), which can perform passive uplink communication by modulating and reflecting a downlink signal received via antenna(s) 590. For example, passive and semi-passive energy harvesting devices may be unable to generate and transmit an uplink signal without first receiving a downlink signal that can be modulated and reflected. In other examples, energy harvesting device 500 may be implemented as an active energy harvesting device, which utilizes a powered transceiver to perform active uplink communication. An active energy harvesting device is able to generate and transmit an uplink signal without first receiving a downlink signal (e.g., by using an on-device power source to energize its powered transceiver).

An ambient energy harvesting device (e.g., active or semi-passive energy harvesting device) may include one or more energy storage elements 585 (e.g., collectively referred to as an “energy reservoir”). For example, the one or more energy storage elements 585 can include batteries, capacitors, etc. In some examples, the one or more energy storage elements 585 may be associated with a boost converter 580. The boost converter 580 can receive as input at least a portion of the energy harvested by energy harvester 530 (e.g., with a remaining portion of the harvested energy being provided as instantaneous power for operating the energy harvesting device 500). In some aspects, the boost converter 580 may be a step-up converter that steps up voltage from its input to its output (e.g., and steps down current from its input to its output). In some examples, boost converter 580 can be used to step up the harvested energy generated by energy harvester 530 to a voltage level associated with charging the one or more energy storage elements 585. An ambient energy harvesting device (e.g., active or semi-passive energy harvesting device) may include one or more energy storage elements 585 and may include one or more boost converters 580. A quantity of energy storage elements 585 may be the same as or different than a quantity of boost converters 580 included in an active or semi-passive energy harvesting device.

A passive energy harvesting device does not include an energy storage element 585 or other on-device power source. For example, a passive energy harvesting device may be powered using only RF energy harvested from a downlink signal (e.g., using energy harvester 530). As mentioned previously, a semi-passive energy harvesting device can include one or more energy storage elements 585 and/or other on-device power sources. The energy storage element 585 of a semi-passive energy harvesting device can be used to augment or supplement the RF energy harvested from a downlink signal. In some cases, the energy storage element 585 of a semi-passive energy harvesting device may store insufficient energy to transmit an uplink communication without first receiving a downlink communication (e.g., minimum transmit power of the semi-passive device>capacity of the energy storage element). An active energy harvesting device can include one or more energy storage elements 585 and/or other on-device power sources that can power uplink communication without using supplemental harvested RF energy (e.g., minimum transmit power of the active device<capacity of the energy storage element). The energy storage element(s) 585 included in an active energy harvesting device and/or a semi-passive energy harvesting device can be charged using harvested RF energy.

As mentioned above, ambient energy harvesting devices (e.g., passive and semi-passive energy harvesting devices) transmit uplink communications by performing backscatter modulation to modulate and reflect a received downlink signal. The received downlink signal is used to provide both electrical power (e.g., to perform demodulation, local processing, and modulation) and a carrier wave for uplink communication (e.g., the reflection of the downlink signal). For example, a portion of the downlink signal will be backscattered as an uplink signal and a remaining portion of the downlinks signal can be used to perform energy harvesting.

Active energy harvesting devices can transmit uplink communications without performing backscatter modulation and without receiving a corresponding downlink signal (e.g., an active energy harvesting device includes an energy storage element to provide electrical power and includes a powered transceiver to generate a carrier wave for an uplink communication). In the absence of a downlink signal, ambient energy harvesting devices (e.g., passive and semi-passive energy harvesting devices) may be unable to transmit an uplink signal (e.g., passive communication). Active energy harvesting devices do not depend on receiving a downlink signal in order to transmit an uplink signal and can transmit an uplink signal as desired (e.g., active communication).

In examples in which the energy harvesting device 500 is implemented as an ambient energy harvesting device (e.g., a passive or semi-passive energy harvesting device), a continuous carrier wave downlink signal may be received using antenna(s) 590 and modulated (e.g., re-modulated) for uplink communication. In some cases, a modulator 560 can be used to modulate the reflected (e.g., backscattered) portion of the downlink signal. For example, the continuous carrier wave may be a continuous sinusoidal wave (e.g., sine or cosine waveform) and modulator 560 can perform modulation based on varying one or more of the amplitude and the phase of the backscattered reflection. Based on modulating the backscattered reflection, modulator 560 can encode digital symbols (e.g., such as binary symbols or more complex systems of symbols) indicative of an uplink communication or data message. For example, the uplink communication may be indicative of sensor data or other information associated with the one or more sensors 570 included in energy harvesting device 500.

As mentioned previously, impedance matching component 510 can be used to match the impedance of antenna(s) 590 to the receive components of energy harvesting device 500 when receiving the downlink signal (e.g., when receiving the continuous carrier wave). In some examples, during backscatter operation (e.g., when transmitting an uplink signal), modulation can be performed based on intentionally mismatching the antenna input impedance to cause a portion of the incident downlink signal to be scattered back. The phase and amplitude of the backscattered reflection may be determined based on the impedance loading on the antenna(s) 590. Based on varying the antenna impedance (e.g., varying the impedance mismatch between antenna(s) 590 and the remaining components of energy harvesting device 500), digital symbols and/or binary information can be encoded (e.g., modulated) onto the backscattered reflection. Varying the antenna impedance to modulate the phase and/or amplitude of the backscattered reflection can be performed using modulator 560.

As illustrated in FIG. 5, a portion of a downlink signal received using antenna(s) 590 can be provided to a demodulator 520, which performs demodulation and provides a downlink communication (e.g., carried or modulated on the downlink signal) to a micro-controller unit (MCU) 550 or other processor included in the energy harvesting device 500. A remaining portion of the downlink signal received using antenna(s) 590 can be provided to energy harvester 530, which harvests RF energy from the downlink signal. For example, energy harvester 530 can harvest RF energy based on performing AC-to-DC (alternating current-to-direct current) conversion, wherein an AC current is generated from the sinusoidal carrier wave of the downlink signal and the converted DC current is used to power the energy harvesting device 500. In some aspects, energy harvester 530 can include one or more rectifiers for performing AC-to-DC conversion. A rectifier can include one or more diodes or thin-film transistors (TFTs). In one illustrative example, energy harvester 530 can include one or more Schottky diode-based rectifiers. In some cases, energy harvester 530 can include one or more TFT-based rectifiers.

The output of the energy harvester 530 is a DC current generated from (e.g., harvested from) the portion of the downlink signal provided to the energy harvester 530. In some aspects, the DC current output of energy harvester 530 may vary with the input provided to the energy harvester 530. For example, an increase in the input current to energy harvester 530 can be associated with an increase in the output DC current generated by energy harvester 530. In some cases, MCU 550 may be associated with a narrow band of acceptable DC current values. Regulator 540 can be used to remove or otherwise decrease variation(s) in the DC current generated as output by energy harvester 530. For example, regulator 540 can remove or smooth spikes (e.g., increases) in the DC current output by energy harvester 530 (e.g., such that the DC current provided as input to MCU 550 by regulator 540 remains below a first threshold). In some cases, regulator 540 can remove or otherwise compensate for drops or decreases in the DC current output by energy harvester 530 (e.g., such that the DC current provided as input to MCU 550 by regulator 540 remains above a second threshold).

In some aspects, the harvested DC current (e.g., generated by energy harvester 530 and regulated upward or downward as needed by regulator 540) can be used to power MCU 550 and one or more additional components included in the energy harvesting device 500. For example, the harvested DC current can additionally be used to power one or more (or all) of the impedance matching component 510, demodulator 520, regulator 540, MCU 550, sensors 570, modulator 560, etc. For example, sensors 570 and modulator 560 can receive at least a portion of the harvested DC current that remains after MCU 550 (e.g., that is not consumed by MCU 550). In some cases, the harvested DC current output by regulator 540 can be provided to MCU 550, modulator 560, and sensors 570 in series, in parallel, or a combination thereof.

In some examples, sensors 570 can be used to obtain sensor data (e.g., such as sensor data associated with an environment in which the energy harvesting device 500 is located). Sensors 570 can include one or more sensors, which may be of a same or different type(s). In some aspects, one or more (or all) of the sensors 570 can be configured to obtain sensor data based on control information included in a downlink signal received using antenna(s) 590. For example, one or more of the sensors 570 can be configured based on a downlink communication obtained based on demodulating a received downlink signal using demodulator 520. In one illustrative example, sensor data can be transmitted based on using modulator 560 to modulate (e.g., vary one or more of amplitude and/or phase of) a backscatter reflection of the continuous carrier wave received at antenna(s) 590. Based on modulating the backscattered reflection, modulator 560 can encode digital symbols (e.g., such as binary symbols or more complex systems of symbols) indicative of an uplink communication or data message. In some examples, modulator 560 can generate an uplink, backscatter modulated signal based on receiving sensor data directly from sensors 570. In some examples, modulator 560 can generate an uplink, backscatter modulated signal based on received sensor data from MCU 550 (e.g., based on MCU 550 receiving sensor data directly from sensors 570).

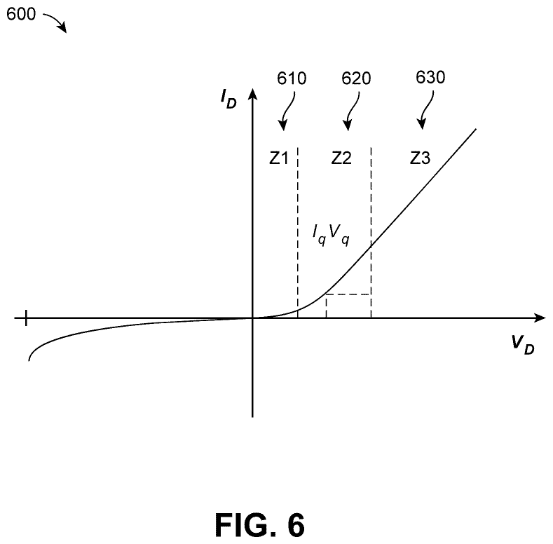

FIG. 6 is a diagram 600 illustrating an example of a small signal rectification operation that may be associated with performing energy harvesting. In one illustrative example, the small signal rectification operation may be a small signal rectification operation associated with a Schottky diode barrier (e.g., a Schottky diode used to perform rectification associated with energy harvester 530 illustrated in FIG. 5).

In some cases, the rectification process in a diode barrier (e.g., Schottky diode or other diode) associated with performing energy harvesting can be classified into small signal operation and large signal operation. For example, large signal operation is associated with rectifying an input signal (e.g., a received downlink signal at an energy harvesting device that includes the diode) having a relatively large amplitude signal that causes the diode to operate in its resistive zone. Small signal operation (e.g., such as the example small signal operation illustrated in FIG. 6) can be associated with rectifying an input signal (e.g., or portion thereof) having a relatively small amplitude signal, such that the diode does not operate in its resistive zone.

For example, small signal operation of a rectifying process in a Schottky diode barrier may be associated with three different operating zones, as depicted in FIG. 6. In a first operating zone 610, the diode behavior may be approximated as quadratic. For example, in the first operating zone 610, the output signal of the diode may be proportional to the square of the input signal to the diode. In some cases, the first operating zone 610 may also be referred to as a square law zone. In a second operating zone 620, the diode behavior may become more affected by other contributions, and the relationship between the output-input signal of the diode may decrease from quadratic towards linear. In some cases, the second operating zone 620 may also be referred to as a transition zone. In a third operating zone 630, the output signal of the diode may be proportional to the input signal to the diode (e.g., a linear relationship between input and output signals of the diode) and no DC component is generated. The third operating zone 630 may also be referred to as a resistive zone.

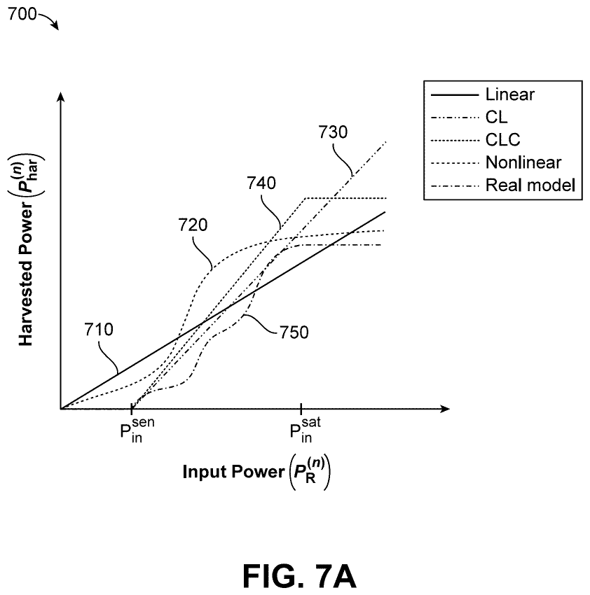

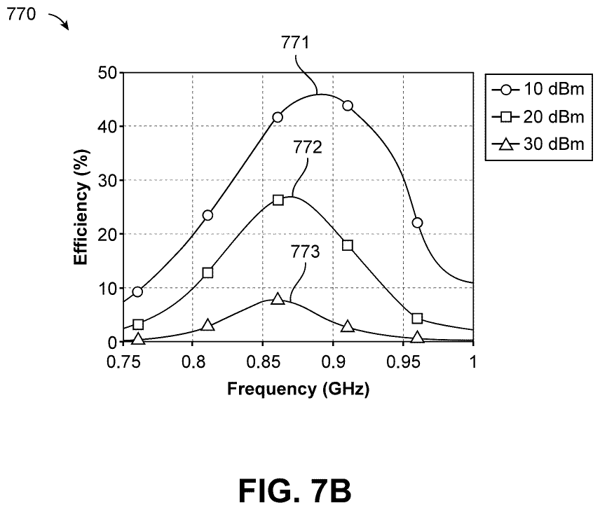

FIG. 7A is a diagram 700 illustrating examples of input power-harvested power conversion models that may be associated with various energy harvesting devices (e.g., such as the energy harvesting device 500 illustrated in the example of FIG. 5, above). Diagram 700 includes a first power conversion model 710, a second power conversion model 720, a third power conversion model 730, a fourth power conversion model 740, and a fifth power conversion model 750. In some aspects, different energy harvesting devices may be associated with different models between input power (e.g., the total RF energy or power of the portion of the received downlink signal provided to energy harvester 530 illustrated in FIG. 5) and harvested power (e.g., the RF energy or power that is harvested and output by energy harvester 530). In some aspects, the power conversion models 710-750 may be associated with ambient energy harvesting devices (e.g., passive and/or semi-passive energy harvesting devices) and/or active energy harvesting devices.

The first power conversion model 710 can be associated with a first type or category of energy harvesting devices. For example, energy harvesting devices having the first power conversion model 710 can provide harvested power as a continuous, linear, increasing function of the input RF power.

The second power conversion model 720 can be associated with a second type or category of energy harvesting devices. For example, energy harvesting devices having the second power conversion model 720 can provide harvested power as a continuous, non-linear, increasing function of the input RF power.

The third power conversion model 730 can be associated with a third type or category of energy harvesting device. For example, energy harvesting devices having the third power conversion model 730 can provide harvested power that is a continuous, linear, increasing function of the input RF power, given that the input RF power is above a sensitivity threshold

$$( {P}_{i n}^{s e n} ) .$$

The sensitivity threshold

$${P}_{i n}^{s e n}$$

can represent a minimum input RF power for which the energy harvesting device is able to perform harvesting (e.g., is able to harvest a non-zero amount of power). When the input RF power is below the sensitivity threshold

$$( {P}_{in}^{sen} ) ,$$

the harvested power is zero.

The fourth power conversion model 740 can be associated with a fourth type or category of energy harvesting device. For example, energy harvesting devices having the fourth power conversion model 740 can provide harvested power that is a continuous, linear, increasing function of the input RF power, given that the input RF power is both above the sensitivity threshold

$${P}_{in}^{sen}$$

and is below a saturation threshold

$${P}_{in}^{sat} .$$

As illustrated, the saturation threshold

$${P}_{in}^{sat}$$

is greater than the sensitivity threshold

$${P}_{in}^{sen} .$$

When the input RF power is below the sensitivity threshold

$${P}_{in}^{sen} ,$$

the harvested power is zero. When the input RF power is above the saturation threshold

$${P}_{in}^{sat} ,$$

the harvested power output saturates (e.g., remains approximately constant for any input RF power above the saturation threshold).

The fifth power conversion model 750 can be associated with a fifth type or category of energy harvesting device. For example, for an input RF power between the sensitivity threshold

$${P}_{in}^{sen}$$

and the saturation threshold

$${P}_{in}^{sat} ,$$

energy harvesting devices having the fifth power conversion model 750 can provide harvested power that is a continuous, non-linear, increasing function of the input RF power.

An efficiency of an energy harvesting device can be determined as a percentage of the input RF power that is converted into harvested power. FIG. 7B is a diagram 770 illustrating an example of energy conversion efficiency versus frequency (e.g., of an input waveform to the energy harvesting device) for different input powers. For example, a first efficiency-frequency relationship 771 is shown for an input RF power of −10 dBm (decibel milliwatts), a second efficiency-frequency relationship 772 is shown for an input RF power of −20 dBm, and a third efficiency-frequency relationship 773 is shown for an input RF power of −30 dBm.

The three efficiency-frequency relationships 771, 772, 773 depicted in FIG. 7B may each be associated with an optimum operating frequency, or an optimum operating frequency band, for which the energy conversion efficiency of a corresponding energy harvesting device is maximized. For example, for an input RF power of −30 dBm, an energy harvesting device with a power conversion model associated with the third efficiency-frequency relationship 773 may maximize its energy conversion efficiency with an input RF waveform centered at a frequency of 0.86 GHz. In another example, for an input RF power of −20 dBm, an energy harvesting device with a power conversion model associated with the second efficiency-frequency relationship 772 may maximize its energy conversion efficiency with an input RF waveform centered at a frequency of 0.87 GHz. In another example, for an input RF power of −10 dBm, an energy harvesting device with a power conversion model associated with the first efficiency-frequency relationship 771 may maximize its energy conversion efficiency with an input RF waveform centered at a frequency of 0.89 GHz.

The efficiency of an energy harvesting device may vary based on the input RF power (e.g., the RF power of the downlink signal received at an antenna of the energy harvesting device) and the center frequency of the input RF waveform. For example, as illustrated in FIG. 7B, the maximum or peak efficiency of an energy harvesting device that receives a relatively low input RF power may be less than the maximum or peak efficiency of an energy harvesting device that receives a relatively high input RF power (e.g., at −30 dBm the peak efficiency of the energy conversion model associated with the third efficiency-frequency relationship 773 is below 10%, at −20 dBm the peak efficiency of the energy conversion model associated with the second efficiency-frequency relationship 772 is approximately 25%, and at −10 dBm the peak efficiency of the energy conversion model associated with the first efficiency-frequency relationship 771 is approximately 45%). In some cases, conversion efficiency can decrease for frequencies that are greater than the optimum input center frequency and can decrease for frequencies that are less than the optimum input center frequency.

In some aspects, the conversion efficiency of an energy harvesting device may be associated with one or more energy conversion characteristics (e.g., also referred to as energy harvesting characteristics). For example, one or more characteristics may be indicative of a relationship between the conversion efficiency of an energy harvesting device and input frequency. In one illustrative example, an energy harvesting device may have an approximately constant conversion efficiency over a narrowband operating bandwidth (e.g., such as 20 MHz or less). In such examples, the energy harvesting device can receive RF energy from a multi-sine downlink wave with uniform power distribution. In another illustrative example, an energy harvesting device with a wideband operating bandwidth (e.g., such as 20 MHz or greater) may have a conversion efficiency that is a non-linear function of input frequency over the wideband. In such examples, the energy harvesting device may receive RF energy based on Gaussian and/or raised-cosine filters being used in combination with (e.g., on top of) the multi-sine downlink wave described above for narrowband operating bandwidths.

In some aspects, the energy conversion efficiency of an energy harvesting device may vary continuously with the input RF power. For example, the energy conversion efficiency may be zero for input powers less than the sensitivity threshold

$$( {P}_{in}^{sen} )$$

(e.g., based on the harvested power being equal to zero when the input RF power is below the sensitivity threshold, and conversion efficiency is equal to harvested power/input RF power). In some examples, the energy conversion efficiency of an energy harvesting device may vary over different input frequencies (e.g., as described above with respect to FIG. 7B) and may additionally vary over different input RF powers. For example, in some cases, the energy conversion efficiency of an energy harvesting device may be approximately linear with input RF power, for input RF power values between the sensitivity threshold

$$( {P}_{in}^{sen} )$$

and a first input RF power value greater than

$${P}_{in}^{sen} .$$

The energy conversion efficiency may increase linearly with the input RF power from and above

$${P}_{in}^{sen} .$$

At input KH powers beyond the linear conversion efficiency zone, the energy conversion efficiency of the energy harvesting device may increase and/or decrease non-linearly with further increases in input RF power. In some examples, the energy conversion efficiency may include one or more additional zones of linear increase (e.g., and/or linear decrease) with input RF power, in addition to an initial linear conversion efficiency zone beginning at the sensitivity threshold

$${P}_{in}^{sen} .$$

As discussed previously, certain aspects of the present disclosure relate to wireless communication systems and devices capable of concurrent WWAN and RFID communications. In a wireless communication network environment (e.g., cellular network, etc.), a network device or entity can be used to transmit downlink RF signals to energy harvesting devices. In some cases, the network device can be a UE (e.g., such as a non-energy harvesting UE), a repeater device, or repeater node, an Integrated Access and Backhaul (IAB) node, or other type of network device. In some cases, the network entity can be a base station (e.g., an eNB, a gNB, etc.) or other type of network entity. In some aspects, the network device or entity may also be referred to herein as an “energy source device,” an “energy transmitter device,” a “scheduler of energy transfer,” and/or an “energy transfer scheduler.” For example, a base station, gNB, UE, repeater device or node, and/or an IAB node may each be referred to as an energy source device, an energy transmitter device, a scheduler of energy transfer, and/or an energy transfer scheduler.

In some examples, an energy source device (e.g., base station, gNB, UE, etc.) can read and/or write information stored on ambient energy harvesting IoT devices by transmitting a downlink RF signal. A downlink RF signal can provide energy to an ambient energy harvesting IoT device and can be used as the basis for an information-bearing uplink signal transmitted back to the energy source device by the ambient energy harvesting IoT device (e.g., based on reflecting or backscattering a portion of the incident downlink RF signal). The energy source device can read the reflected signal transmitted by an ambient energy harvesting IoT device to decode the information transmitted by the IoT device (e.g., such as sensor information collected by one or more sensors included in the IoT device, etc.).

In an example, disclosed systems include processors or chipsets that can configure one or more antennas to connect and/or communicate with one or more WWAN networks and energize RFID devices such as energy harvesting devices. As noted previously, as used herein, “configuring an antenna” or “reconfiguring an antenna” includes adjusting or tuning receive and/or transmit chains through which a baseband signal is translated from or to a signal compatible with the antenna, and/or includes programming additional functionality, such as impedance and/or antenna aperture tuners to align the antenna to a frequency band of interest. Such systems enable reuse of resources (e.g., processors, antennas, and/or RF systems), which can reduce cost and power consumption in wireless devices (e.g., mobile devices, such as UEs). In this manner, antennas and/or compute resources may be dynamically reallocated from WWAN communications to RFID communications and/or from RFID communications to WWAN communications. For instance, an RFID system may emit continuous wave transmissions that energize RFID harvesting devices while simultaneously communicating on one or more WWANs. Such concurrency enables end user applications to use RFID, while maintaining connectivity with cellular systems, such as NR (5G), LTE, 3G, Global System for Mobile Communication (GSM), and so forth. RFID communications may involve emitting an inventory sequence, an example of which is provided in FIG. 8.

FIG. 8 is a diagram illustrating an example of an RFID inventory sequence 800. FIG. 8 depicts time-division duplexing (TDD), including alternating transmissions such as continuous wave (CW) transmissions, and reception of messages from an energy harvesting device such as a tag.

One or more RFID tags may be read in sequence. Sequence 800 includes an example single tag read sequence 810 and a multi-tag read sequence 860. As depicted, single tag read sequence 810 and the multi-tag read sequence 860 include a sequence of various transmissions and receptions. Sequences 810 and 860 are exemplary; variations are possible.

The sequence 810 and the sequence 860 each include various continuous wave segments, during which a continuous wave is emitted via an antenna. The sequence 810 and the sequence 860 also each include various receive segments, during which the device listens for transmissions from the one or more RFID tags. The CW energizes any tags within range, or if the tags are already energized, maintains the tags energized before the tags are read.

The single tag read sequence 810 includes CW 812, select 814, CW 816, query 818, CW 820 (and RN16 message 840), Acknowledgement (ACK) 822, and CW 824 (and EPC message 842). In the single tag read sequence 810, a reader device can use the sequence Query(T)→RN16(R)→ACK(T)→EPC(R) to read one tag, where “T” refers to the reader transmitting and “R” refers to the reader receiving (i.e., the tag transmitting). For instance, the reader device can first transmit a CW 812. In the example depicted, the transmission time is 1.5 milliseconds (ms), but other durations are possible.

Continuing the example, the reader device then transmits a Select(T)/Challenge(T) message 814 to one or more tags. The reader device transmits a second CW 816 for a time T₄. In response, the tag emits the RN16 message 840, T₁ time after a start of CW 820, ending T₂ time before the end of CW 820. During this time, the reader continues to emit a CW 820. The reader responds with an ACK message 822. In response, the tag emits an EPC message 842, while the reader continues to emit CW 824. The EPC message is emitted T₁ time after the start of CW 824, but T₂ time before the end of the period corresponding to CW 824.

The RFID specification provides for a potentially short turnaround time for timers T₁ and T₂. This short turnaround time causes a need for substantial computational resources, in addition to at least one antenna for RFID application. In some cases, meeting additional requirements may be required. Such requirements may include Frequency-Hopping Spread Spectrum (FHSS) spectrum signaling for UL in the USA and a need to meet Anti-Jammer requirements in the European Union (EU).

The multi sequence 860 includes the operations of the single tag read sequence 810, followed by one or more repetitions of parts of the sequence 810, such as Query rep 826, CW 828, ACK 830, CW 832, query rep 834, RN16 message 844, and EPC message 846. More specifically, the multi-tag read sequence 860 includes messages QueryRep(T)→RN16(R)→ACK(T)→EPC(R) to read subsequent tags, which follows the initial message sequence, with a particular pre-defined timing cadence. These messages may be repeated, once for each additional tag.

A duration of the sequences depends on a particular configuration that the reader selects for transmit and receive data transmissions. In an example, a typical duration of the single tag read sequence 810 is from 1.2 to 50 ms. By contrast, the multi tag read sequence 860 may range as follows:

$$\{ 1.2 - 50 \} + ( a no\_of \_tags read ) * \{ 0.5 - 41 \} ms$$

In some cases, at least 1.5 ms may be needed to power up the tags before sending any commands.

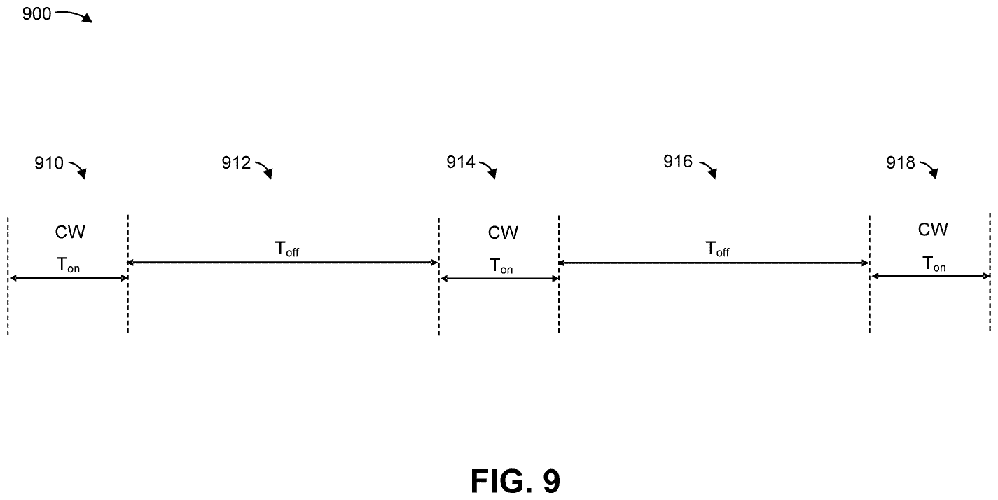

FIG. 9 is a diagram illustrating an example 900 of RFID tones. Example 900 illustrates various miscellaneous aspects of RFID technology that may be relevant to certain aspects.

As depicted, the example 900 includes five time periods 910, 912, 914, 916, and 918. But, other time periods are possible. In the example depicted, during time period 910, a CW is emitted for Tₒₙ time. A tag may charge an embedded capacitor during time period 910, which can enable the tag to respond during subsequent time periods, such as time period 912. As depicted, time period 912 has a period of length T_{off} time. During time period 914, a CW is emitted for Tₒₙ time. During time period 916, more tags may emit messages during T_{off} time. During time period 918, a CW is emitted for Tₒₙ time.

As discussed, certain aspects relate to improved wireless communication systems and devices capable of concurrent WWAN and RFID communications. As explained further below, disclosed systems may leverage periods of Discontinuous Reception (DRX) to enable RFID functionality. DRX is an energy saving technique that allows a user device to intermittently check for incoming downlink traffic.

The energy efficiency of wireless communication between client devices (e.g., UEs, etc.) and base stations (e.g., gNBs, etc.) can vary based on various factors. As used herein, the “energy efficiency” associated with wireless communications at a UE or base station may be referred to interchangeably as the “power consumption” associated with the wireless communications at the UE or base station.

Power consumption for wireless communications can include a power consumption associated with transmitting wireless signals and a power consumption associated with receiving wireless signals. For example, a UE power consumption can include the power consumption associated with the UE actively transmitting wireless signals (e.g., to a base station or gNB) and the power consumption associated with the UE actively receiving wireless signals (e.g., from a base station or gNB).

In addition to the power consumption associated with actively transmitting or receiving, a UE additionally consumes power while in an active or ‘On’ state where the UE is configured to be continuously ready to transmit or receive data. For instance, a UE consumes power while waiting to receive data from a base station or gNB, even when no data is being transmitted by the base station or gNB. The UE remains continuously awake in order to decode downlink data, as the data in the downlink may arrive at any time. The UE may monitor a physical downlink control channel (PDCCH) in every subframe to check whether a PDCCH is available for scheduling or otherwise indicating downlink data for the UE. By continuously monitoring PDCCH for possible downlink (DL) and/or uplink (UL) data, the UE may consume a large portion of the available power at the UE (e.g., a large portion of the available battery power at the UE).

In some cases, power saving techniques can be implemented for client devices, for base stations, and/or for a combination of the two. Some power saving techniques are based on managing the energy efficiency or energy consumption of various periodic communications between UEs and base stations. For example, discontinuous reception (DRX) can be used to configure PDCCH periodic monitoring, where a UE wakes up to monitor for downlink data during a periodic DRX-enabled state and enters a low-power sleep or idle mode outside of the periodic DRX-enabled state (e.g., during a DRX-disabled state). Discontinuous transmission (DTX) can be used to configure periodic transmission of uplink signals by a UE (e.g., during a periodic DTX-enabled state), where the UE enters the low-power sleep or idle mode outside of the periodic DTX-enabled state (e.g., during a DTX-disabled state).

In some cases, DRX implemented by a UE can also be referred to as connected mode DRX. The connected mode DRX can be used to improve UE battery power consumption based on the UE periodically entering a ‘sleep’ state for an ‘off-duration’ during which the UE does not monitor PDCCH. To monitor PDCCH for possible downlink/uplink data, the UE can be configured to wake up periodically and remain in an ‘awake’ state for an ‘on-duration.’ DRX implemented by a UE can also be referred to as “UE-DRX.”

DRX implemented by a UE can include various types of DRX. For instance, one type of UE-DRX is Inactivity-based DRX (e.g., I-DRX). A UE implementing I-DRX may enter a low-power state when the UE is not actively engaged in data transmission or reception. For instance, an inactivity period can be defined or configured for I-DRX by the network. In I-DRX mode, a UE discontinuously receives data by periodically waking up to listen for a paging signal or other control information from the network. If there is nothing to receive (e.g., as indicated by a paging signal or other control information), the UE can return to the low-power state until the next scheduled wake-up time.

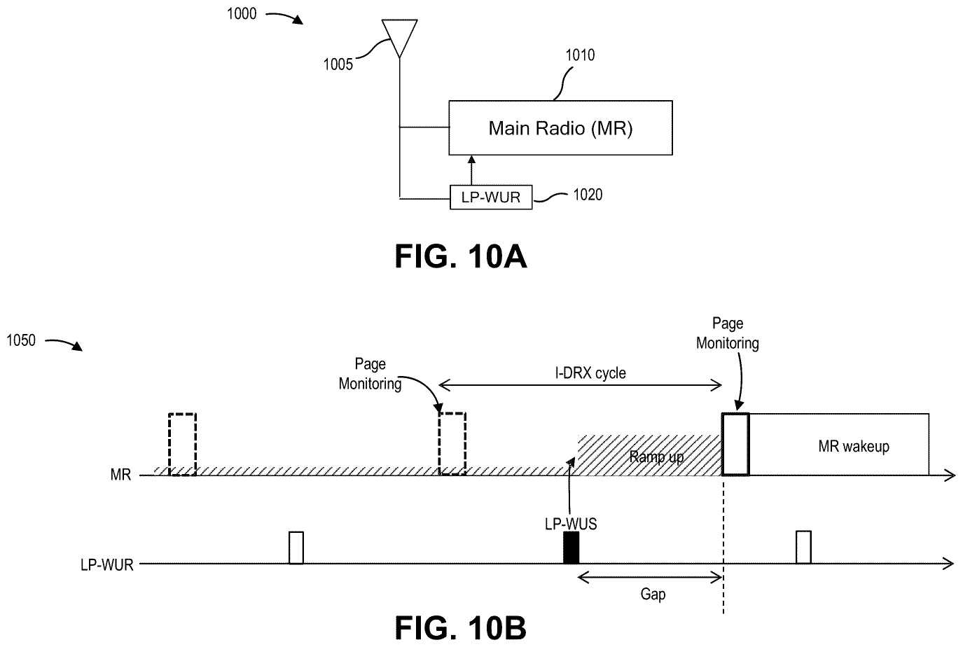

FIGS. 10A and 10B illustrate a communication system 1000 that may implement DRX. FIG. 10A is a diagram illustrating an example of a communication system 1000 (e.g., wireless communication device, such as a UE) including a main radio (MR) and a low-power wake-up receiver (LP-WUR) associated with the MR. In addition to latency, reliability, and availability, UE energy efficiency is an important factor for the design of wireless communication systems and standards, including 5G NR and beyond. Energy efficiency can be an important consideration for UEs without a continuous energy source device (e.g., UEs using small rechargeable batteries, single coin cell batteries, etc.). Some UEs may be implemented as IoT UEs, such as connected sensors or actuators, and may be deployed with non-rechargeable batteries and used for purposes such as monitoring, measuring, etc. Wearables devices can include wearable UEs, such as smart watches, rings, health-related devices, medical monitoring devices, etc., and may struggle to sustain a battery life of one to two weeks as is required.

In some examples, the communication system 1000 (a wireless communication device such as a UE) can include a low-power wake-up receiver (LP-WUR) 1020 and a main radio (MR) 1010. The LP-WUR 1020 can be a companion receiver of the MR 1010, and may be implemented in parallel with the MR 1010. For instance, the LP-WUR 1020 and the MR 1010 may share antenna 1005 of the communication system 1000. The power consumption of a UE can be based on the configured length of wake-up periods (e.g., paging cycle). Currently, UEs may need to periodically wake up once per discontinuous reception (DRX) cycle, an action which can dominate the UE power consumption in periods with no signaling or data traffic to the UE. The LP-WUR 1020 can be used to cause the UE to wake up only when the UE is triggered to do so by the network or a network entity. Using the LP-WUR 1020 to wake the communication system 1000 (e.g., using the LP-WUR 1020 to wake the MR 1010 of the communication system 1000) can reduce paging and power consumption of the communication system 1000. For instance, a wake-up signal (WUS) can be used to cause the MR 1010 to wake up and/or exit a deep sleep state. The LP-WUR 1020 is a separate receiver from the MR 1010, and can be configured with the ability to monitor for a WUS or other low-power signal, using a lesser power consumption than the MR 1010.

In some case, the LP-WUR 1020 may be configured to perform continuous monitoring for a LP-WUS. In some examples, the LP-WUR 1020 can be configured to perform discontinuous monitoring for a LP-WUS, for instance with T milliseconds (ms) as the period to complete an on-and-off discontinuous LP-WUS monitoring cycle by the LP-WUR 1020, and D ms as the active time for monitoring LP-WUS every cycle.

FIG. 10B is a diagram illustrating an example of wireless communications 1050 performed using the MR 1010 and LP-WUR 1020 of FIG. 10A. A communications timeline is shown corresponding to the MR 1010 of FIG. 10A in the upper portion of FIG. 10B, and a communications timeline is shown corresponding to the LP-WUR 1020 of FIG. 10A in the lower portion of FIG. 10B. In some examples, the MR can be associated with a plurality of page monitoring occasions, which corresponding to a configured length of wake-up periods for receiving and/or transmitting control information and/or data by the MR of the UE. In some cases, a page monitoring occasion can correspond to a wake-up period or paging cycle of the UE and the MR. For instance, each page monitoring occasion can correspond to an I-DRX cycle.

The LP-WUR can be implemented as a companion receiver off the MR, and can be configured to process low-power wake-up signals (LP-WUSs) transmitted by a network entity (e.g., base station, gNB, etc.). In some cases, the LP-WUR can additionally process one or more control signals from the network entity. In some examples, the use of the LP-WUR can allow the MR to skip one or more page monitoring occasions, and remain in a deep sleep state (e.g., an ultra-deep sleep state) during the one or more skipped page monitoring occasions. During a page monitoring occasion skipped by the MR, the LP-WUR can monitor for a LP-WUS on a LP-WUS monitoring occasion that corresponds to at least one of the skipped page monitoring occasions of the MR. For example, the LP-WUR can monitor for a LP-WUS on a LP-WUS monitoring occasion that is between the first and second skipped page monitoring occasions of the MR, as shown in the timelines of FIG. 10B.

Based on not receiving a LP-WUS during the LP-WUS monitoring occasion, the LP-WUR may take no action, and can allow the MR to remain in ultra-deep sleep state. In the second LP-WUS monitoring occasion shown in FIG. 10B for the LP-WUR timeline, the LP-WUR receives an LP-WUS from the network entity (e.g., gNB, base station, etc.). The network entity may transmit the LP-WUS to be indicative of traffic arriving at the gNB for the UE (e.g., traffic arriving at the gNB needing the MR of the UE for receiving). Based on receiving the LP-WUS in the second LP-WUS monitoring occasion, the LP-WUR can trigger the MR to exit the deep sleep state. For instance, the LP-WUR can transmit a wake-up signal (WUS) to the MR, based on the LP-WUR receiving the LP-WUS from the network entity.

The MR can begin exiting the deep sleep state and transitioning to an active (e.g., on or awake) state, with a corresponding transition or ramp up time between the MR receiving the trigger to exit the deep sleep state and the MR reaching the awake state, where the MR is ready to receive data traffic from the network entity. For instance, the ramp up period of the MR wakeup can be associated with a time delay or time gap relative to the receipt of the LP-WUS at the LP-WUR, as shown in FIG. 10B. In some cases, the LP-WUS can be configured with transmission timing such that the LP-WUR triggers the MR to wake up sufficiently early relative to the next page monitoring occasion (e.g., next I-DRX cycle). Based on completing the ramp up and entering the awake state by the beginning of the next page monitoring occasion for the next I-DRX cycle, the MR of the UE is able to receive the transmitted data from the network entity at high speed during the MR wakeup period corresponding to the received LP-WUS.

As noted previously, systems and techniques described herein facilitate concurrent communication of WWAN and RFID signals. The systems and techniques can permit a more granular coordination between RFID and WWAN stacks. A stack, or a subscription, may refer to a set of architectural layers that describe network transactions and communications between devices, implemented in software and/or hardware. Such coordination assists in lowering power consumption relative to existing solutions, which may employ multiple parallel sets of resources such as antennas, RF baseband resources, and so forth.

The systems and techniques can provide improvements relative to existing solutions. For example, in some existing systems, if a WWAN stack is operating a voice call, RFID operations are interrupted for an entire duration of the voice call, making receiving RFID tones from an energy harvesting device (e.g., a tag) impossible. By contrast, the systems and techniques described herein can continue to emit continuous wave communications during voice activity, ensuring that when the voice call is finished, such RFID tones may be received and processed.

In one illustrative example, a mobile device can be in a WWAN Radio Access Technology (RAT) active state and may need to initiate an RFID transaction. In some cases, the mobile device's WWAN resources may be shared with the RFID system, including continuous wave emission to an RFID device (e.g., to energize an ambient energy harvesting IoT device) and reception of communications from the RFID device (e.g., backscatter signals from the ambient energy harvesting IoT device). In a resource constrained environment (e.g., with limited antennas and/or compute resources), resources may be reallocated. For example, a single antenna may be reused between WWAN and RFID. Compute resources may also be shared, for instance, processing RFID transactions when the WWAN stack is inactive. The disclosed systems and techniques are applicable to any type of voice calls (e.g., Voice over Internet Protocol Multimedia Subsystem (VoIMS), Carrier-Interferometry WLAN (or CI-WLAN), Circuit-Switched (CS) calls, and/or data-based voice calls) and video calls, and can operate when a call is active or in the “hold” state.

In some cases, the systems and techniques described herein can leverage Discontinuous reception (DRX) and/or Connected Mode DRX (CDRX) for RFID functionality. For instance, the systems and techniques can operate WWAN and RFID on a time-multiplexed basis, according to a state of CDRX (e.g., active versus inactive).

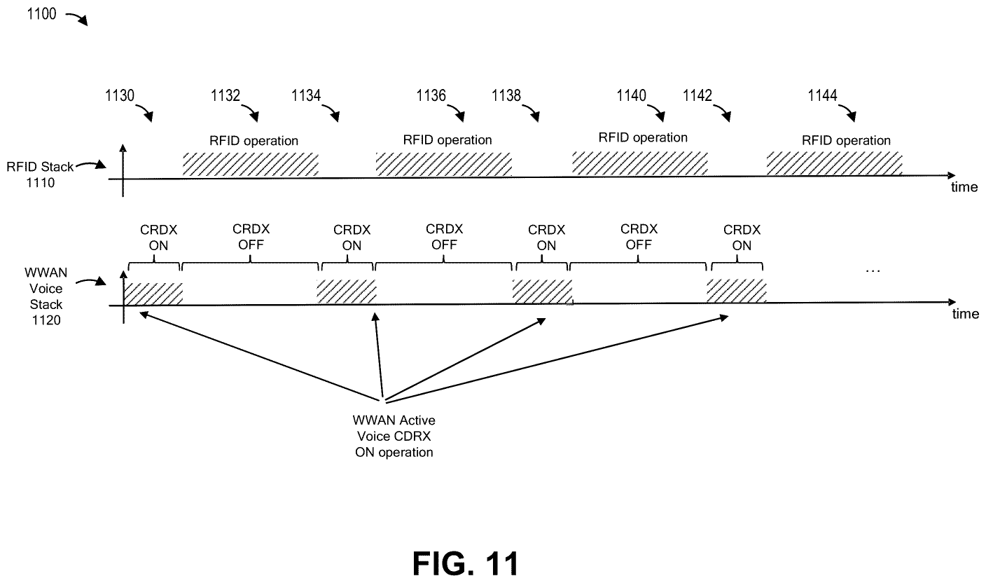

FIG. 11 is a diagram illustrating an example 1100 of time multiplexed WWAN and RFID communication. Example 1100 represents an implementation of WWAN and RFID, specifically, facilitating voice calls or other periodic data communications on the WWAN while maintaining RFID operations. In the example depicted, a wireless communication system causes periodic RFID communications (e.g., “keep alive” messages, such as a continuous wave transmission used to energize one or more RFID devices, such as one or more ambient energy harvesting IoT devices) to be transmitted when an RFID stack 1110 is suspended during an active WWAN voice call using a WWAN voice stack 1120. While a WWAN voice call is used as an illustrative example in FIG. 11, the example of FIG. 11 can be used for other active uses of the WWAN, such as during video playback over WWAN.

Example 1100 includes operations performed by RFID stack 1110 and various operations performed by WWAN voice stack 1120. In some examples, RFID stack 1110 and WWAN voice stack 1120 may be implemented by user device computing system 470 of FIG. 4. For instance, user device computing system 470 of FIG. 4 may concurrently execute both the RFID stack 1110 and the WWAN stack 1120. Example 1100 enables both the receiving and initiation of calls, while keeping an RFID session open during any calls. Further, RFID processing may be resumed following the ending of a call.

As depicted, example 1100 includes various time periods 1130, 1132, 1134, 1136, 1138, 1140, 1142, and 1144. Time periods 1130, 1134, 1138, and 1142 correspond to a state of CDRX active (on) for a WWAN call. During time periods 1130, 1134, 1138, and 1142, WWAN communications may take place. By contrast, time periods 1132, 1136, 1140, and 1144 correspond to a state of CDRX inactive (off). During time periods 1132, 1136, 1140, and 1144, resources may be repurposed for RFID operations.

Voice operations may be transmitted using the WWAN voice stack 1120 during CDRX active periods, specifically during time periods 1130, 1134, 1138, and 1142. By contrast, RFID messages may be transmitted using the RFID stack 1110 during time periods 1132, 1136, 1140, and 1144. Any transmissions needing to occur during these periods may be buffered.

This functionality may be implemented by providing CDRX periodicity and CDRX OFF durations to the RFID stack 1110 and/or devices. Various operations may be performed during the CDRX inactive time periods, such as an active RFID scan, sending “keep alive” messages or CW transmissions, and so forth. The RFID communications (e.g., “keep alive” messages) may be aligned in a WWAN or CDRX OFF duration for coexistence (coex) band combinations. In one or more examples, the RFID “keep alive” messages may be transmitted in a CW transmission burst at a requisite power to reach all of the RFID tags within a range to keep the RFID tags powered up.

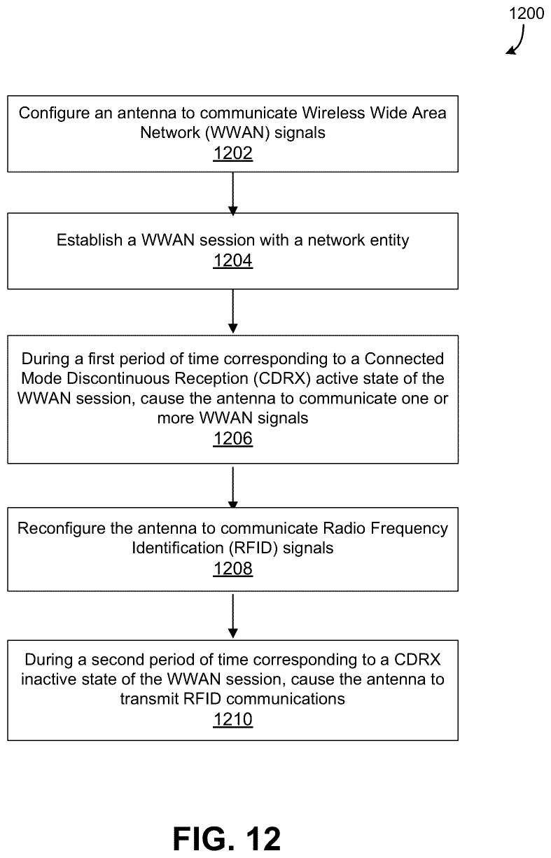

In some cases, in the CDRX inactive periods, the WWAN stack 1120 may be given priority over the RFID stack 1110. Examples of such scenarios include aperiodic transmission of Channel Quality Indicators (CQI), Sounding Reference Signal (SRS) communications, Hybrid Automatic Repeat Request (HARQ) Feedback transmission, and/or other communications. In such scenarios, WWAN UL transmission will take place despite CDRX being inactive (e.g., CDRX OFF). FIG. 12 described below depicts an example of a method corresponding to the aspects depicted in FIG. 11.

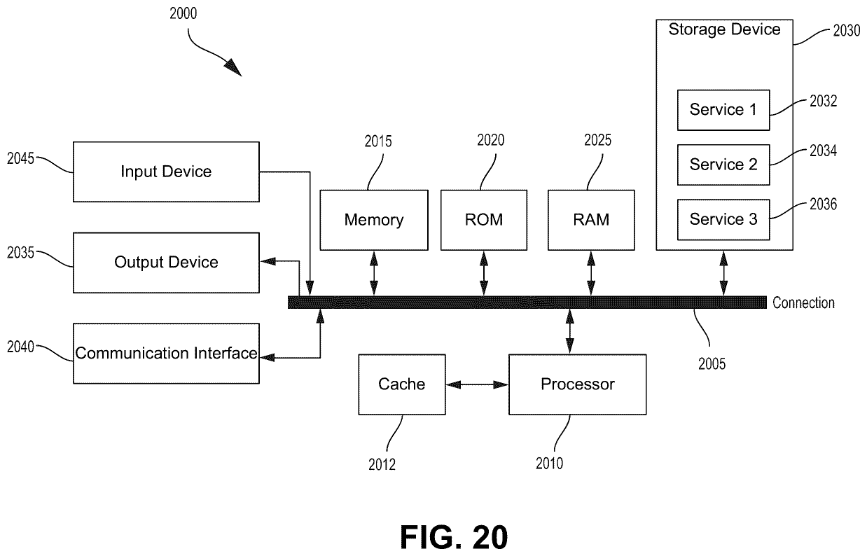

FIG. 12 is a flowchart diagram illustrating an example of a process 1200 for wireless communications. The process 1200 may be performed by a network entity or by a component or system (e.g., a chipset) of the network entity. The network entity can be an energy transmitter device, energy source device, and/or scheduler of energy transfer associated with an ambient IoT device (e.g., such as the ambient IoT device that may be used to perform the process 1200 of FIG. 12). In some examples, the network entity is a base station (e.g., the base station 102 of FIG. 1 and/or FIG. 2, or the disaggregated base station 300 of FIG. 3) or a portion of the base station (e.g., the CU 310, the DU 330, the RU 340, the Near-RT RIC 325, the Non-RT RIC 315, and/or or other portion of the disaggregated base station 300). In some examples, the network entity is a gNB, a UE (e.g., including a non-ambient IoT UE), a repeater node, an IAB node, etc. The operations of the process 1200 may be implemented as software components that are executed and run on one or more processors (e.g., processor 2010 of FIG. 20 or other processor(s)). Further, the transmission and reception of signals by the network entity in the process 1200 may be enabled, for example, by one or more antennas and/or one or more transceivers (e.g., antenna(s) and/or wireless transceiver(s) of any of FIG. 2, FIG. 4, FIG. 5, etc.).

At block 1202, the process 1200 involves the system configuring an antenna to communicate WWAN signals. As noted above, as used herein, “configuring an antenna” or “reconfiguring an antenna” includes adjusting or tuning receive and/or transmit chains through which a baseband signal is translated from or to a signal compatible with the antenna, and/or includes programming additional functionality, such as impedance and/or antenna aperture tuners to align the antenna to a frequency band of interest.

At block 1204, the process 1200 involves the system establishing a WWAN session with a network entity (e.g., a base station, such as an eNB, gNB, etc., or a portion of the base station such as a CU, a DU, a RU, a Near-RT RIC, or a Non-RT RIC of a disaggregated base station).

At block 1206, the process 1200 involves the system, during a first period of time corresponding to a CDRX active state of the WWAN session, causing the antenna to communicate one or more WWAN signals.

At block 1208, the process 1200 involves the system reconfiguring the antenna to communicate RFID signals.

At block 1210, the process 1200 involves the system, during a second period of time corresponding to a CDRX inactive state of the WWAN session, causing the antenna to communicate RFID signals.

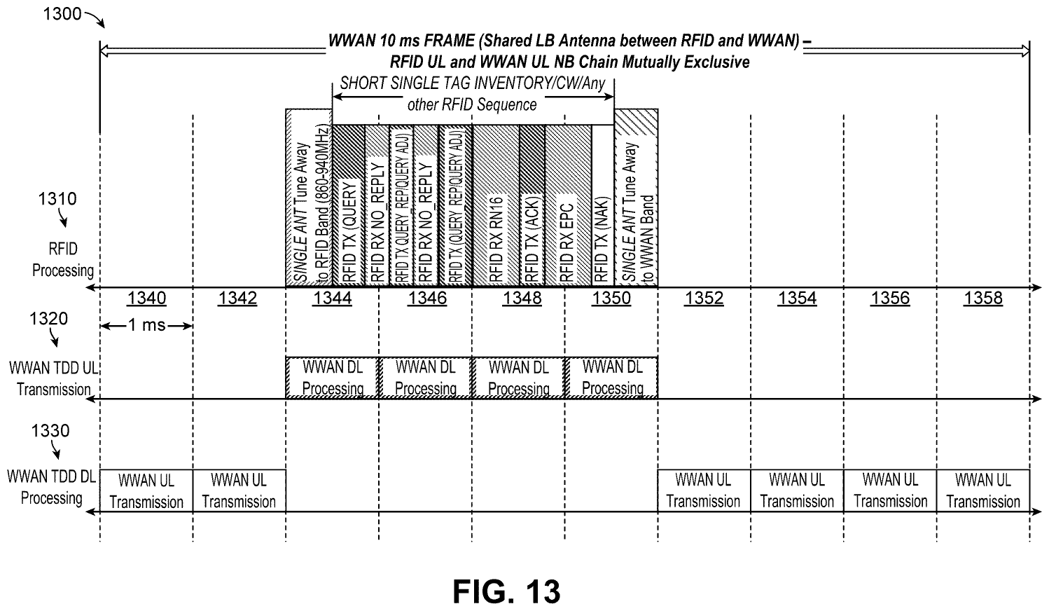

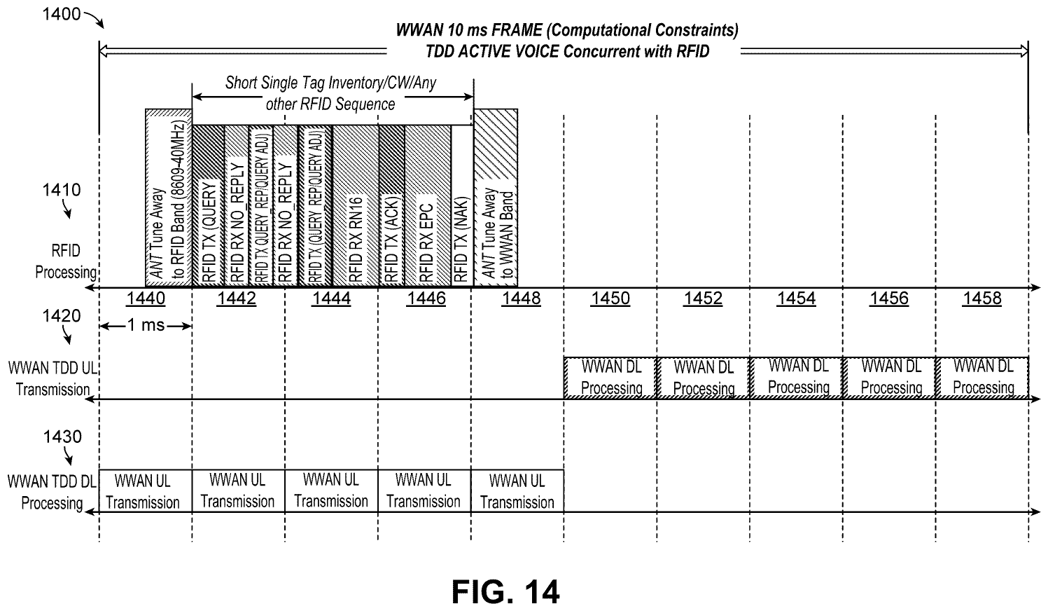

In some aspects, RFID processing may be implemented concurrently with WWAN processing, for example, by being interleaved with WWAN time slots. This approach may be used with high priority (e.g., low latency requirement) data traffic such as voice or video. As discussed below, these cases may include antenna-constrained scenarios (as illustrated further in FIG. 13) and computationally-constrained scenarios (as illustrated further in FIG. 14). While various examples are discussed with respect to FIGS. 13 and 14, such as RFID communication within uplink or downlink slots of a frame, any split between upload and download is possible. For instance, in one example, where for example in a frame with 10 slots, two slots may be used for uplink and eight slots may be used for downlink. In another example, two slots may be used for downlink and eight slots may be used for uplink. The configuration of ten slots per frame is applicable to a 15 kilohertz (kHz) subcarrier spacing (SCS). In a configuration with a 30 kHz SCS, the split amongst slots could be four slots for uplink and sixteen slots for downlink, or sixteen slots for uplink and four slots for downlink. Other examples are possible.

FIG. 13 is a diagram illustrating an example 1300 of combined WWAN and RFID communication in an antenna-constrained scenario. Example 1300 includes RFID processing 1310, WWAN upload transmission 1320, and WWAN download transmission 1330, across various time periods 1340, 1342, 1344, 1346, 1348, 1350, 1352, 1354, 1356, and 1358. The examples discussed with respect to FIG. 14 apply equally to the sharing of a sole antenna between the RFID system and the WWAN system, and to the sharing of a single antenna of multiple antennas.

For example, a transmit antenna may be shared between RFID and WWAN in a time-duplexed manner. For example, RFID transmission may occur concurrently with WWAN reception in TDD-DL slots. In this scenario, a WWAN Precoding Matrix Indicator (PMI)/Rank Indicator (RI)/Channel Quality Indicator (CQI) may be sent (e.g., at the start of concurrent operation and until the end), as one less antenna is available. An Appropriate Antenna Diversity Path (ARD) reconfiguration is initiated in the handset WWAN processing. This assumes that the pattern chosen is such that the number of contiguous download slots are sufficiently long enough for an RFID single or multi-tag sequence.

As depicted, during time periods 1340, 1342, 1352, 1354, 1356, and 1358, WWAN upload operations occur. By contrast, during time periods 1344, 1346, 1348, and 1350, WWAN download operations and RFID operations occur. One or more antennas may be repurposed. As depicted, during periods 1344, 1346, 1348, and 1350, the RFID operations performed include antenna tuning from WWAN to RFID, sequences of transmission and reception (e.g., corresponding to sequences depicted in FIG. 8), and finally antenna tuning from RFID to WWAN.

FIG. 14 is a diagram illustrating an example 1400 of combined WWAN and RFID communication in a computationally constrained scenario. Example 1400 includes RFID processing 1410, WWAN upload transmission 1420, and WWAN download transmission 1430, across various time periods 1440, 1442, 1444, 1446, 1448, 1450, 1452, 1454, 1456, and 1458. RFID processing may be computationally intensive and the available resources may not permit such processing when the WWAN upload or download processing is active. As explained below, in both cases, an RFID scan may take place concurrently with WWAN calls.

In this aspect, RFID is scheduled only during the TDD UL slots of a TDD Slot Pattern. This is possible because DL processing for WWAN may be more computationally intensive compared to UL WWAN and assumes the pattern chosen is such that the number of contiguous UL slots are sufficiently long enough for an RFID single or multi-tag sequence. Further, in this case, a number of contiguous UL slots configured are assumed to be sufficiently long enough for an RFID single Tag sequence/CW transmission or a multi-tag sequence to occur.

In the event of an unexpected computation resource bottleneck, graceful degradation procedures may be employed. Such procedures include giving priority to WWAN (i) during an uplink control periodic or semi-persistent CQI/RI/PMI/AP-CSI UL transmission; (ii) during an UL scheduling request, aperiodic CQI/SRS or HARQ Feedback UL transmission; and/or (iii) for all remaining UL Physical Uplink Shared Channel (PUSCH) frames carrying signaling information. For any remaining UL PUSCH data frames carrying user data, grants may be given to WWAN at least every alternate radio frame.

As depicted, during time periods 1440, 1442, 1444, 1446, and 1448, WWAN upload operations and RFID operations may take place. By contrast, during time periods 1450, 1452, 1454, 1456, and 1458, WWAN download operations can take place. The RFID operations can include one or more sequences of transmission and reception (e.g., corresponding to the sequences depicted in FIG. 8).

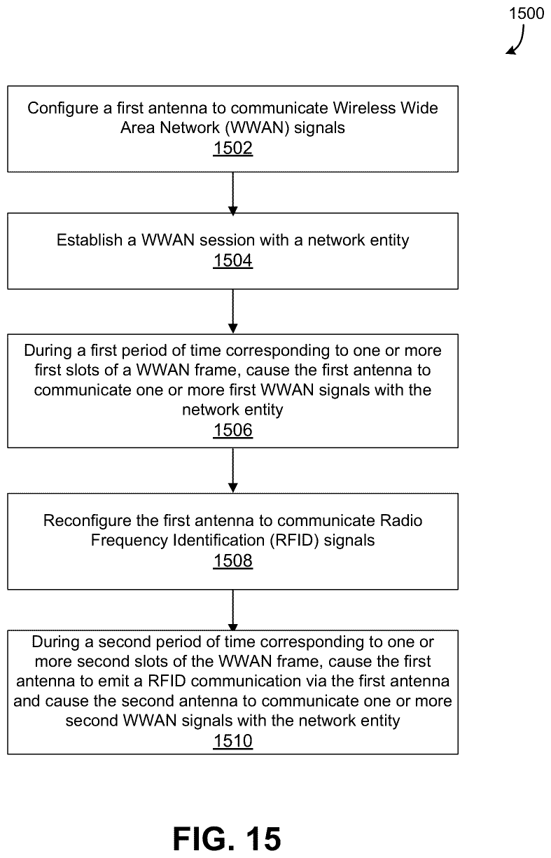

FIG. 15 is a flowchart diagram illustrating an example of a process 1500 for wireless communications. Process 1500 may be invoked in a resource-constrained scenario.

The process 1500 may be performed by a network entity or by a component or system (e.g., a chipset) of the network entity. The network entity can be an energy transmitter device, energy source device, and/or scheduler of energy transfer associated with an ambient IoT device (e.g., such as the ambient IoT device that may be used to perform the process 1500 of FIG. 15). In some examples, the network entity is a base station (e.g., the base station 102 of FIG. 1 and/or FIG. 2, or the disaggregated base station 300 of FIG. 3) or a portion of the base station (e.g., the CU 310, the DU 330, the RU 340, the Near-RT RIC 325, the Non-RT RIC 315, and/or or other portion of the disaggregated base station 300). In some examples, the network entity is a gNB, a UE (e.g., including a non-ambient IoT UE), a repeater node, an IAB node, etc. The operations of the process 1500 may be implemented as software components that are executed and run on one or more processors (e.g., processor 2010 of FIG. 20 or other processor(s)). Further, the transmission and reception of signals by the network entity in the process 1500 may be enabled, for example, by one or more antennas and/or one or more transceivers (e.g., antenna(s) and/or wireless transceiver(s) of any of FIG. 2, FIG. 4, FIG. 5, etc.).

At block 1502, the process 1500 involves the system configuring a first antenna and a second antenna to communicate WWAN signals.

At block 1504, the process 1500 involves the system establishing a WWAN session with a network entity (e.g., a base station, such as an eNB, gNB, etc., or a portion of the base station such as a CU, a DU, a RU, a Near-RT RIC, or a Non-RT RIC of a disaggregated base station).

At block 1506, the process 1500 involves the system, during a first period of time corresponding to one or more first slots of a WWAN frame, causing the first antenna to communicate one or more first WWAN signals with the network entity.

At block 1508, the process 1500 involves the system reconfiguring the first antenna to communicate RFID signals.

At block 1510, the process 1500 involves the system, during a second period of time corresponding to one or more second slots of the WWAN frame, causing the first antenna to emit an RFID communication via the first antenna and causing the second antenna to communicate one or more second WWAN signals with the network entity.

In an aspect, RFID processing may be interleaved into WWAN time slots. This may be possible when there is no uplink or downlink semi-persistent data transfer or associated physical layer control. This scenario may occur when a voice call, video call, or any other form of high priority periodic data transfer occurs that uses semi-persistent scheduling in the WWAN but RFID needs to be fully concurrent with WWAN.

In these scenarios, either an antenna or compute constrained situation may arise. For instance, both WWAN and RFID may share one or more antennas. In other cases, computational constraints may exist because computationally expensive RFID processing cannot execute when WWAN uplink or downlink is active, due to the resources used by the WWAN.

In an example, once semi persistent scheduling (SPS) is configured and activation starts in the WWAN, the predominant usage of data transfer is typically a periodic transmission for voice or video. In an example, the periodicity may be 20 ms or 40 ms (but other durations are possible). In this case, the WWAN may typically utilize a only a subset of the total time (e.g., a few ms) for data transfer. Once the data transfer is complete, the remaining duration can be used for RFID operations, including, if appropriate, antenna retuning.

In these cases, during periodic or semi-persistent CQI/RI/PMI UL transmission, CSI transmission, or WWAN UL Control Channel Signaling, priority is given to WWAN. Similarly, during aperiodic CQI/SRS or HARQ Feedback UL transmission, priority is given to WWAN also.

In an antenna-constrained scenario, WWAN PMI/RI/CQI is sent (at the start of SPS activation) to reflect operation with one less antenna. Appropriate Antenna Diversity Path (ARD) reconfiguration is initiated in UE WWAN processing. Normally all antennas are used in NR transmission and when RFID is used, therefore at least one antenna resource should be released for RFID. If there is an unexpected data reception during the time RFID is active, the DL processing is still received, with the remaining antennas connected for the WWAN. In the case of a single antenna, WWAN communication is not possible when RFID is active.

For unexpected WWAN UL traffic needing to occur during RFID operation, the transmit MAC layer waits for appropriate RFID operation completion before initiating WWAN traffic. If SPS de-activation is received, after stoppage of the WWAN calls, the DL still can handle its processing even during the RFID is off, using any remaining antennas. Regular data processing can then be initiated for WWAN.

In a computationally constrained scenario, any unexpected UL data packet processing outside the SPS scheduling slots, can be given a best effort, with priority given to RFID. In the event that packet processing is delayed for too long or missed, a re-transmission can be sent. This is ensured by always ensuring a few empty slots after typical periodic WWAN traffic stops, but before RFID communication is resumed. If a SPS de-activation is received when the RFID is off, it is possible a packet can get missed, but the packet will eventually be processed during a re-transmission.

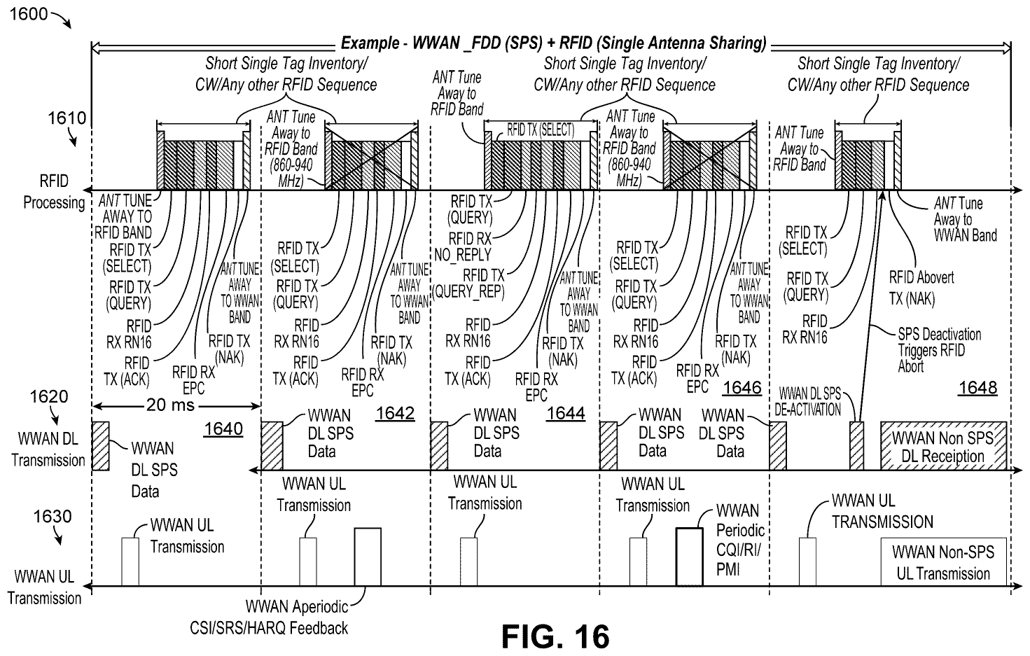

FIG. 16 is a diagram illustrating an example 1600 of combined WWAN and RFID communication. Example 1600 includes RFID processing 1610, WWAN upload transmission 1620, and WWAN download transmission 1630, across various time periods 1640, 1642, 1644, 1646, and 1648. Each time period is 20 milliseconds (ms), but can be of any duration.

During each time period 1640, 1642, 1644, 1646, and 1648, communication may occur as follows: WWAN download, WWAN upload, and RFID communications. For instance, in time period 1640, WWAN DL SPS data is transmitted, then a WWAN upload takes place, and then RFID communication occurs. The RFID operations include one or more sequences of transmission and reception (e.g., corresponding to the sequences depicted in FIG. 8). However, priority is given to the WWAN communications if a conflict exists.

For example, in some time periods, one or more events may occur such that the RFID communication never starts or, if already commenced, is abandoned. For example, as shown in period 1642, when any critical UL control signaling, such as a WWAN aperiodic CSI/SRS/HARQ feedbackA event occurs, RFID processing may not take place. Similarly, in time period 1646, when a WWAN periodic CQI/RI/PMI communication takes place, RFID processing may not take place. In time period 1648, when a WWAN DL SPS deactivation takes place, RFID processing is abandoned.

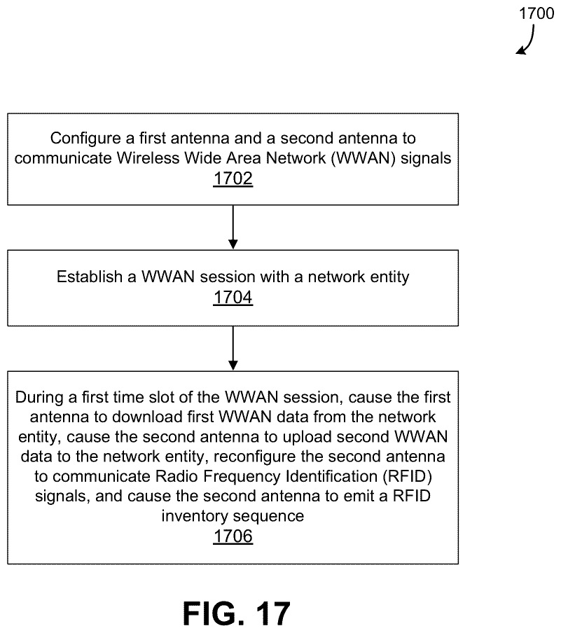

FIG. 17 is a flowchart diagram illustrating an example of a process 1700 for wireless communications.

The process 1700 may be performed by a network entity or by a component or system (e.g., a chipset) of the network entity. The network entity can be an energy transmitter device, energy source device, and/or scheduler of energy transfer associated with an ambient IoT device (e.g., such as the ambient IoT device that may be used to perform the process 1700 of FIG. 17). In some examples, the network entity is a base station (e.g., the base station 102 of FIG. 1 and/or FIG. 2, or the disaggregated base station 300 of FIG. 3) or a portion of the base station (e.g., the CU 310, the DU 330, the RU 340, the Near-RT RIC 325, the Non-RT RIC 317, and/or or other portion of the disaggregated base station 300). In some examples, the network entity is a gNB, a UE (e.g., including a non-ambient IoT UE), a repeater node, an IAB node, etc. The operations of the process 1700 may be implemented as software components that are executed and run on one or more processors (e.g., processor 2010 of FIG. 20 or other processor(s)). Further, the transmission and reception of signals by the network entity in the process 1700 may be enabled, for example, by one or more antennas and/or one or more transceivers (e.g., antenna(s) and/or wireless transceiver(s) of any of FIG. 2, FIG. 4, FIG. 5, etc.).

At block 1702, the process 1700 involves the system configuring a first antenna and a second antenna to communicate WWAN signals.

At block 1704, the process 1700 involves the system establishing a WWAN session with a network entity (e.g., a base station, such as an eNB, gNB, etc., or a portion of the base station such as a CU, a DU, a RU, a Near-RT RIC, or a Non-RT RIC of a disaggregated base station).

At block 1706, the process 1700 involves the system, during a first period of time of the WWAN session, causing the first antenna to communicate first WWAN data from the network entity, causing the second antenna to communicate second WWAN data to the network entity, reconfiguring the second antenna to communicate RFID signals, and causing the second antenna to emit a RFID signal.

In some aspects, a voice call may be briefly put on hold to facilitate RFID operations. In this manner, RFID may be activated and operated during a hold, and the call may be resumed when the RFID operations are complete. During a call, a periodic Real-Time Transport Control Protocol (RTCP) packet transmission may take place. During such a hold call, RFID communication may be activated. To keep a voice call in a hold state without dropping the call, the RFID data can be periodically suspended and a silent voice packet (e.g., VoLTE/VoNR RTCP packet) can be sent, which ensures that the call can be resumed when the RFID communication is complete.

Advantages to this approach include using a single radio. In some scenarios, RFID may be deprioritized, such as when an aperiodic CQI, SRS, and HARQ Feedback transmission is required (e.g., since in these scenarios, a WWAN UL transmission occurs despite CDRX OFF).

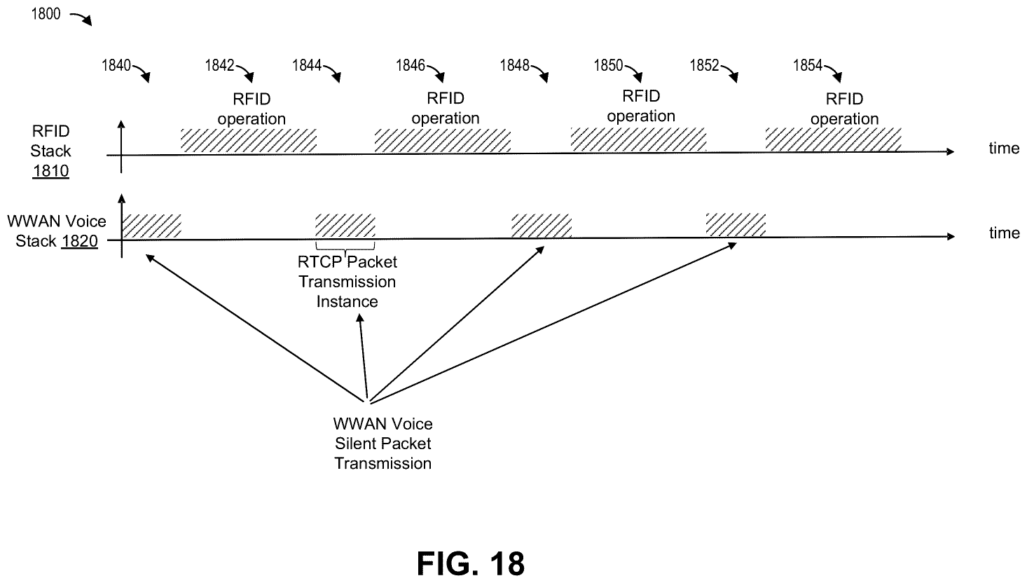

FIG. 18 is a diagram illustrating an example 1800 of combined WWAN and RFID communication. Example 1100 depicts putting a voice call on hold and performing RFID operations. Example 1800 includes an RFID stack 1810 and WWAN voice stack 1820, which can communicate across various time periods 1840, 1842, 1844, 1846, 1848, 1850, 1852, and 1854.

As can be seen, during periods 1840, 1844, 1848, and 1852, the RFID operations are ceased such that a WWAN voice silent transmission may take place. By contrast, during periods 1842, 1846, 1850, and 1854, RFID communications may take place.

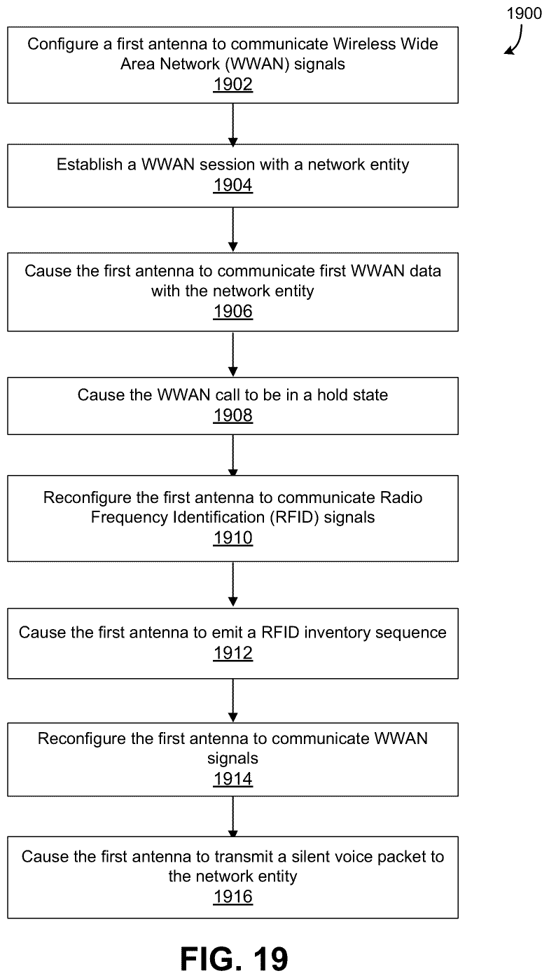

FIG. 19 is a flowchart diagram illustrating an example of a process 1900 for wireless communications. The process 1900 may be performed by a network entity or by a component or system (e.g., a chipset) of the network entity. The network entity can be an energy transmitter device, energy source device, and/or scheduler of energy transfer associated with an ambient IoT device (e.g., such as the ambient IoT device that may be used to perform the process 1900 of FIG. 19). In some examples, the network entity is a base station (e.g., the base station 102 of FIG. 1 and/or FIG. 2, or the disaggregated base station 300 of FIG. 3) or a portion of the base station (e.g., the CU 310, the DU 330, the RU 340, the Near-RT RIC 325, the Non-RT RIC 319, and/or or other portion of the disaggregated base station 300). In some examples, the network entity is a gNB, a UE (e.g., including a non-ambient IoT UE), a repeater node, an IAB node, etc. The operations of the process 1900 may be implemented as software components that are executed and run on one or more processors (e.g., processor 2010 of FIG. 20 or other processor(s)). Further, the transmission and reception of signals by the network entity in the process 1900 may be enabled, for example, by one or more antennas and/or one or more transceivers (e.g., antenna(s) and/or wireless transceiver(s) of any of FIG. 2, FIG. 4, FIG. 5, etc.).

At block 1902, the process 1900 involves configuring a first antenna to communicate WWAN signals.

At block 1904, the process 1900 involves establishing an active WWAN call with a network entity (e.g., a base station, such as an eNB, gNB, etc., or a portion of the base station such as a CU, a DU, a RU, a Near-RT RIC, or a Non-RT RIC of a disaggregated base station).

At block 1906, the process 1900 involves causing the first antenna to communicate first WWAN data with the network entity.

At block 1908, the process 1900 involves causing the WWAN call to be in a hold state.

At block 1910, the process 1900 involves reconfiguring the first antenna to communicate RFID signals.

At block 1912, the process 1900 involves causing the first antenna to emit an RFID inventory sequence.

At block 1914, the process 1900 involves reconfiguring the first antenna to communicate WWAN signals. The WWAN signals may include a voice silent packet transmission.

At block 1916, the process 1900 involves causing the first antenna to transmit a silent voice packet to the network entity.

In some examples, the processes described herein (e.g., processes 1200, 1500, 1700, and 1900, and/or other process described herein) may be performed by a computing device or apparatus (e.g., a network node such as a UE, base station, a portion of a base station, etc.). For example, as noted above, the process 1200 may be performed by a UE. As further noted above, the process 1900 may be performed by a base station (e.g., the base station 102 of FIG. 1 and/or FIG. 2, or the disaggregated base station 300 of FIG. 3) or a portion of the base station (e.g., the CU 310, the DU 330, the RU 340, the Near-RT RIC 325, the Non-RT RIC 315, and/or or other portion of the disaggregated base station 300).

In some cases, the computing device or apparatus may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, one or more network interfaces configured to communicate and/or receive the data, any combination thereof, and/or other component(s). The one or more network interfaces may be configured to communicate and/or receive wired and/or wireless data, including data according to the 3G, 4G, 5G, and/or other cellular standard, data according to the WiFi (802.11x) standards, data according to the Bluetooth™ standard, data according to the Internet Protocol (IP) standard, and/or other types of data.

The components of the computing device may be implemented in circuitry. For example, the components may include and/or may be implemented using electronic circuits or other electronic hardware, which may include one or more programmable electronic circuits (e.g., microprocessors, graphics processing units (GPUs), digital signal processors (DSPs), central processing units (CPUs), and/or other suitable electronic circuits), and/or may include and/or be implemented using computer software, firmware, or any combination thereof, to perform the various operations described herein.

The processes 1200, 1500, 1700, and 1900 are each illustrated as a logical flow diagram, the operation of which represent a sequence of operations that may be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations may be combined in any order and/or in parallel to implement the processes.

Additionally, the processes 1200, 1500, 1700, and 1900, and/or other process described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 20 is a diagram illustrating an example of a system for implementing certain aspects of the present technology. In particular, FIG. 20 illustrates an example of computing system 2000, which may be for example any computing device making up internal computing system, a remote computing system, a camera, or any component thereof in which the components of the system are in communication with each other using connection 2005. Connection 2005 may be a physical connection using a bus, or a direct connection into processor 2010, such as in a chipset architecture. Connection 2005 may also be a virtual connection, networked connection, or logical connection.

In some aspects, computing system 2000 is a distributed system in which the functions described in this disclosure may be distributed within a datacenter, multiple data centers, a peer network, etc. In some aspects, one or more of the described system components represents many such components each performing some or all of the function for which the component is described. In some aspects, the components may be physical or virtual devices.

Example system 2000 includes at least one processing unit (CPU or processor) 2010 and connection 2005 that communicatively couples various system components including system memory 2015, such as read-only memory (ROM) 2020 and random access memory (RAM) 2025 to processor 2010. Computing system 2000 may include a cache 2012 of high-speed memory connected directly with, in close proximity to, or integrated as part of processor 2010.

Processor 2010 may include any general-purpose processor and a hardware service or software service, such as services 2032, 2034, and 2036 stored in storage device 2030, configured to control processor 2010 as well as a special-purpose processor where software instructions are incorporated into the actual processor design. Processor 2010 may essentially be a completely self-contained computing system, containing multiple cores or processors, a bus, memory controller, cache, etc. A multi-core processor may be symmetric or asymmetric.

To enable user interaction, computing system 2000 includes an input device 2045, which may represent any number of input mechanisms, such as a microphone for speech, a touch-sensitive screen for gesture or graphical input, keyboard, mouse, motion input, speech, etc. Computing system 2000 may also include output device 2035, which may be one or more of a number of output mechanisms. In some instances, multimodal systems may enable a user to provide multiple types of input/output to communicate with computing system 2000.

Computing system 2000 may include communications interface 2040, which may generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 2040 may also include one or more Global Navigation Satellite System (GNSS) receivers or transceivers that are used to determine a location of the computing system 2000 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 2030 may be a non-volatile and/or non-transitory and/or computer-readable memory device and may be a hard disk or other types of computer readable media which may store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L#) cache), resistive random-access memory (RRAM/ReRAM), phase change memory (PCM), spin transfer torque RAM (STT-RAM), another memory chip or cartridge, and/or a combination thereof.

The storage device 2030 may include software services, servers, services, etc., that when the code that defines such software is executed by the processor 2010, it causes the system to perform a function. In some aspects, a hardware service that performs a particular function may include the software component stored in a computer-readable medium in connection with the necessary hardware components, such as processor 2010, connection 2005, output device 2035, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data may be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc., may be passed, forwarded, or transmitted via any suitable means including memory sharing, message passing, token passing, network transmission, or the like.

Specific details are provided in the description above to provide a thorough understanding of the aspects and examples provided herein, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects may be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual aspects may be described above as a process or method which is depicted as a flowchart, a flow diagram, a data flow diagram, a structure diagram, or a block diagram. Although a flowchart may describe the operations as a sequential process, many of the operations may be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination may correspond to a return of the function to the calling function or the main function.

Processes and methods according to the above-described examples may be implemented using computer-executable instructions that are stored or otherwise available from computer-readable media. Such instructions may include, for example, instructions and data which cause or otherwise configure a general purpose computer, special purpose computer, or a processing device to perform a certain function or group of functions. Portions of computer resources used may be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some aspects the computer-readable storage devices, mediums, and memories may include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and may take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also may be embodied in peripherals or add-in cards. Such functionality may also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that may be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein may be replaced with less than or equal to (“≤”) and greater than or equal to (“≥”) symbols, respectively, without departing from the scope of this description.

Where components are described as being “configured to” perform certain operations, such configuration may be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B.

Claim language or other language reciting “at least one processor configured to,” “at least one processor being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Aspect 1. An apparatus for wireless communications, comprising: at least one memory; and at least one processor coupled to the at least one memory, the at least one processor configured to: configure an antenna to communicate Wireless Wide Area Network (WWAN) signals; establish a WWAN session with a network entity; during a first period of time corresponding to a Connected Mode Discontinuous Reception (CDRX) active state of the WWAN session, cause the antenna to communicate one or more WWAN signals; reconfigure the antenna to communicate Radio Frequency Identification (RFID) signals; and during a second period of time corresponding to a CDRX inactive state of the WWAN session, cause the antenna to communicate RFID signals.

Aspect 2. The apparatus of Aspect 1, wherein the at least one processor is configured to: cause the antenna to transmit an RFID communication; receive, via the antenna, data from one or more RFID tags; and process the received data.

Aspect 3. The apparatus of any of Aspects 1 or 2, wherein the at least one processor is configured to transmit RFID continuous wave transmissions on a periodic basis.

Aspect 4. The apparatus of any of Aspect 3, wherein the RFID continuous wave transmissions maintain one or more RFID energy harvesting devices in an awake state.

Aspect 5. The apparatus of any of Aspects 1 to 4, wherein the second period of time occurs subsequent to an end of the first period of time.

Aspect 6. The apparatus of any of Aspects 1 to 5, wherein the at least one processor is configured to: during the second period of time, identify that a WWAN upload is required, interrupt the RFID signals, and reconfigure the antenna to communicate the WWAN signals; and cause the antenna to transmit WWAN communications to the network entity.

Aspect 7. The apparatus of Aspect 6, wherein the WWAN upload is responsive to an aperiodic CSI, an aperiodic CQI, a SRS, or a HARQ feedback.

Aspect 8. The apparatus of any of Aspects 1 to 7, wherein the at least one processor is configured to repeat operations of the first period of time with a periodicity corresponding to required communications for a voice call.

Aspect 9. The apparatus of any of Aspects 1 to 8, wherein the at least one processor is configured to repeat operations of the first period of time with a periodicity corresponding to a periodicity of one or more video frames of a video signal.

Aspect 10. An apparatus for wireless communications, comprising: at least one memory; and at least one processor coupled to the at least one memory, the at least one processor configured to: configure a first antenna and a second antenna to communicate Wireless Wide Area Network (WWAN) signals; establish a WWAN session with a network entity; during a first period of time corresponding to one or more first slots of a WWAN frame, cause the first antenna to communicate one or more first WWAN signals with the network entity; reconfigure the first antenna to communicate Radio Frequency Identification (RFID) signals; and during a second period of time corresponding to one or more second slots of the WWAN frame, cause the first antenna to communicate an RFID communication and cause the second antenna to communicate one or more second WWAN signals with the network entity.

Aspect 11. The apparatus of Aspect 10, wherein the WWAN frame comprises a duration of 10 milliseconds (ms) and each slot of the one or more first slots comprises a duration of 1 ms.

Aspect 12. The apparatus of any of Aspects 10 or 11, wherein the one or more first slots comprise six slots and the one or more second slots comprise four slots or the one or more first slots comprise five slots and the one or more second slots comprise five slots.

Aspect 13. The apparatus of any of Aspects 10 to 12, wherein the WWAN frame is a Long Term Evolution (LTE) frame.

Aspect 14. The apparatus of any of Aspects 10 to 13, wherein the WWAN frame is a Fifth Generation (5G) frame.

Aspect 15. The apparatus of any of Aspects 10 to 14, wherein one or more second slots of the WWAN frame are scheduled for downlink WWAN data and/or WWAN signaling.

Aspect 16. The apparatus of any of Aspects 10 to 15, wherein one or more second slots of the WWAN frame are scheduled for uplink WWAN data and/or WWAN signaling.

Aspect 17. The apparatus of any of Aspects 10 to 16, wherein the WWAN frame is a Time Division (TDD) Duplex frame.

Aspect 18. The apparatus of any of Aspects 10 to 17, wherein the first period of time corresponds to a periodicity of required communications for a voice call.

Aspect 19. The apparatus of any of Aspects 10 to 18, wherein the first period of time corresponds to a periodicity of required communications for a video call.

Aspect 20. The apparatus of any of Aspects 10 to 19, wherein: to communicate the one or more first WWAN signals, the first antenna is configured to transmit the one or more first WWAN signals to the network entity; and to communicate the one or more second WWAN signals, the second antenna is configured to receive the one or more second WWAN signals from the network entity.

Aspect 21. The apparatus of any of Aspects 10 to 20, wherein: to communicate the one or more first WWAN signals, the first antenna is configured to receive the one or more first WWAN signals from the network entity; and to communicate the one or more second WWAN signals, the second antenna is configured to transmit the one or more second WWAN signals to the network entity.

Aspect 22. The apparatus of any of Aspects 10 to 21, wherein an RFID communication comprises at least one of: a RFID inventory sequence, a RFID select sequence, or a RFID access sequence.

Aspect 23. An apparatus for wireless communications, comprising: at least one memory; and at least one processor coupled to the at least one memory, the at least one processor configured to: configure a first antenna and a second antenna to communicate Wireless Wide Area Network (WWAN) signals; establish a WWAN session with a network entity; and during a first period of time of the WWAN session, cause the first antenna to communicate first WWAN data from the network entity, cause the second antenna to communicate second WWAN data to the network entity, reconfigure the second antenna to communicate Radio Frequency Identification (RFID) signals, and cause the second antenna to communicate an RFID communication.

Aspect 24. The apparatus of Aspect 23, wherein the first period of time corresponds to a WWAN Semi Persistent Scheduling (SPS) data transfer.

Aspect 25. The apparatus of any of Aspects 23 or 24, wherein communicating the first WWAN data comprises performing a download of WWAN SPS data and wherein communicating the second WWAN data comprises performing an uplink transmission.

Aspect 26. The apparatus of any of Aspects 23 to 25, wherein the at least one processor is further configured to: during a second time period of time of the WWAN session, cause the first antenna to communicate third WWAN data with the network entity, cause the second antenna to communicate fourth WWAN data with the network entity, reconfigure the second antenna to communicate RFID signals, and cause the second antenna to communicate an additional RFID signal.

Aspect 27. The apparatus of any of Aspects 23 to 26, wherein the first period of time corresponds to a periodicity of required communications for a voice call.

Aspect 28. The apparatus of any of Aspects 23 to 27, wherein the first period of time corresponds to a periodicity of required communications for a video call.

Aspect 29. The apparatus of any of Aspects 23 to 28, wherein the at least one processor is further configured to reconfigure the first antenna to communicate WWAN signals.

Aspect 30. An apparatus for wireless communications, comprising: at least one memory; and at least one processor coupled to the at least one memory, the at least one processor configured to: configure a first antenna to communicate Wireless Wide Area Network (WWAN) signals; establish an active WWAN call with a network entity; cause the first antenna to communicate first WWAN data with the network entity; cause the active WWAN call to be in a hold state; reconfigure the first antenna to communicate Radio Frequency Identification (RFID) signals; cause the first antenna to emit an RFID communication; reconfigure the first antenna to communicate WWAN signals; and cause the first antenna to transmit a silent voice packet to the network entity.

Aspect 31. The apparatus of Aspect 30, wherein the at least one processor is further configured to: identifying an uplink control signal; and prioritize WWAN communications over RFID communications.

Aspect 32. A method comprising: configuring an antenna to communicate Wireless Wide Area Network (WWAN) signals; establishing a WWAN session with a network entity; during a first period of time corresponding to a Connected Mode Discontinuous Reception (CDRX) active state of the WWAN session, causing the antenna to communicate one or more WWAN signals; reconfiguring the antenna to communicate Radio Frequency Identification (RFID) signals; and during a second period of time corresponding to a CDRX inactive state of the WWAN session, causing the antenna to transmit additional RFID signals.

Aspect 33. The method of Aspect 32, further comprising: causing the antenna to transmit an RFID communication; receiving, via the antenna, data from one or more RFID tags; and processing the received data.

Aspect 34. The method of any of Aspects 32 or 33, further comprising transmitting RFID continuous wave transmissions on a periodic basis.

Aspect 35. The method of any of Aspects 32 to 34, wherein the RFID signals maintain one or more RFID energy harvesting devices in an awake state.

Aspect 36. The method of any of Aspects 32 to 35, wherein the second period of time occurs subsequent to an end of the first period of time.

Aspect 37. The method of any of Aspects 32 to 36, further comprising: during the second period of time, identifying that a WWAN upload is required, interrupting the additional RFID signals, and reconfiguring the antenna to communicate the WWAN signals; and causing the first antenna to transmit WWAN communications to the network entity.

Aspect 38. The method of Aspect 37, wherein the WWAN upload is responsive to an uplink control signal, an aperiodic CSI, aperiodic CQI, a SRS, or a HARQ feedback.

Aspect 39. The method of any of Aspects 37 or 38, further comprising repeating operations of the first period of time with a periodicity corresponding to required communications for a voice call.

Aspect 40. The method of any of Aspects 32 to 39, further comprising repeating operations of the first period of time with a periodicity corresponding to a periodicity of one or more video frames of a video signal.

Aspect 41. The method of any of Aspects 32 to 40, wherein the RFID signals are configured to maintain one or more RFID energy harvesting devices in an awake state.

Aspect 42. A method comprising: configuring a first antenna and a second antenna to communicate Wireless Wide Area Network (WWAN) signals; establishing a WWAN session with a network entity; during a first period of time corresponding to one or more first slots of a WWAN frame, causing the first antenna to communicate one or more first WWAN signals with the network entity; reconfiguring the first antenna to communicate Radio Frequency Identification (RFID) signals; and during a second period of time corresponding to one or more second slots of the WWAN frame, causing the first antenna to communicate an RFID communication and causing the second antenna to communicate one or more second WWAN signals with the network entity.

Aspect 43. The method of Aspect 42, wherein the WWAN frame comprises a duration of 10 milliseconds (ms) and each slot of the one or more first slots comprises a duration of 1 ms.

Aspect 44. The method of any of Aspects 42 or 43, wherein the one or more first slots comprise six slots and the one or more second slots comprise four slots or the one or more first slots comprise five slots and the one or more second slots comprise five slots.

Aspect 45. The method of any of Aspects 42 to 44, wherein the WWAN frame is a Long Term Evolution (LTE) frame.

Aspect 46. The method of any of Aspects 42 to 45, wherein the WWAN frame is a Fifth Generation (5G) frame.

Aspect 47. The method of any of Aspects 42 to 46, wherein one or more second slots of the WWAN frame are scheduled for downlink WWAN data and/or WWAN signaling.

Aspect 48. The method of any of Aspects 42 to 47, wherein one or more second slots of the WWAN frame are scheduled for uplink WWAN data and/or WWAN signaling.

Aspect 50. The method of any of Aspects 42 to 48, wherein the first period of time corresponds to a periodicity of required communications for a voice call.

Aspect 51. The method of any of Aspects 42 to 49, wherein the first period of time corresponds to a periodicity of required communications for a video call.

Aspect 52. The apparatus of any of Aspects 42 to 41, wherein the WWAN frame is a Time Division (TDD) Duplex frame.

Aspect 52. The method of any of Aspects 42 to 51, wherein communicating the one or more first WWAN signals via the first antenna comprises transmitting the one or more first WWAN signals to the network entity, and wherein communicating the one or more second WWAN signals on the second antenna comprises receiving the one or more second WWAN signals from the network entity.

Aspect 53. The method of any of Aspects 42 to 52, wherein communicating the one or more first WWAN signals via the first antenna comprises receiving the one or more first WWAN signals from the network entity and wherein communicating the one or more second WWAN signals on the second antenna comprises transmitting the one or more second WWAN signals to the network entity.

Aspect 54. The method of any of Aspects 42 to 53, wherein an RFID communication comprises at least one of: a RFID inventory sequence, a RFID select sequence, or a RFID access sequence.

Aspect 55. A method comprising: configuring a first antenna and a second antenna to communicate Wireless Wide Area Network (WWAN) signals; establishing a WWAN session with a network entity; and during a first period of time of the WWAN session, causing the first antenna to communicate first WWAN data with the network entity, causing the second antenna to communicate second WWAN data with the network entity, reconfiguring the second antenna to communicate Radio Frequency Identification (RFID) signals, and causing the second antenna to communicate an RFID signal.

Aspect 56. The method of Aspect 55, wherein the first period of time corresponds to a WWAN Semi Persistent Scheduling (SPS) data transfer.

Aspect 57. The method of any of Aspects 55 or 56, wherein communicating the first WWAN data comprises performing a download of WWAN SPS data and wherein communicating the second WWAN data comprises performing an uplink transmission.

Aspect 58. The method of any of Aspects 55 to 57, further comprising: during a second time period of time of the WWAN session, cause the first antenna to communicate third WWAN data with the network entity, cause the second antenna to communicate fourth WWAN data with the network entity, reconfigure the second antenna to communicate RFID signals, and cause the second antenna to communicate an additional RFID signal.

Aspect 59. The method of any of Aspects 55 to 58, wherein the first period of time corresponds to a periodicity of required communications for a voice call.

Aspect 60. The method of any of Aspects 55 to 59, wherein the first period of time corresponds to a periodicity of required communications for a video call.

Aspect 61. The method of any of Aspects 55 to 60, further comprising reconfiguring the first antenna to communicate WWAN signals.

Aspect 62. A method comprising: configuring a first antenna to communicate Wireless Wide Area Network (WWAN) signals; establishing an active WWAN call with a network entity; causing the first antenna to communicate first WWAN data with the network entity; causing the active WWAN call to be in a hold state; reconfiguring the first antenna to communicate Radio Frequency Identification (RFID) signals; causing the first antenna to communicate an RFID communication; reconfiguring the first antenna to communicate WWAN signals; and causing the first antenna to transmit a silent voice packet to the network entity.

Aspect 63. The method of Aspect 63, further comprising: identifying an uplink control signal; and prioritizing WWAN communications over RFID communications.

Aspect 64. A non-transitory computer-readable medium having stored thereon instructions that, when executed by at least one processor, cause the at least one processor to perform operations according to any one or more of Aspects 1 to 63.

Aspect 65. An apparatus including one or more means for performing operations according to any one or more of Aspects 1 to 63.

What is claimed is:

1. An apparatus for wireless communications, comprising:
at least one memory; and
at least one processor coupled to the at least one memory, the at least one processor configured to:
configure an antenna to communicate Wireless Wide Area Network (WWAN) signals;
establish a WWAN session with a network entity;
during a first period of time corresponding to a Connected Mode Discontinuous Reception (CDRX) active state of the WWAN session, cause the antenna to communicate one or more WWAN signals;
reconfigure the antenna to communicate Radio Frequency Identification (RFID) signals; and
during a second period of time corresponding to a CDRX inactive state of the WWAN session, cause the antenna to communicate RFID signals.

2. The apparatus of claim 1, wherein the at least one processor is configured to:
cause the antenna to transmit an RFID inventory sequence;
receive, via the antenna, data from one or more RFID tags; and
process the received data.

3. The apparatus of claim 1, wherein the at least one processor is configured to transmit RFID continuous wave transmissions on a periodic basis.

4. The apparatus of claim 3, wherein the RFID continuous wave transmissions maintain one or more RFID energy harvesting devices in an awake state.

5. The apparatus of claim 1, wherein the second period of time occurs subsequent to an end of the first period of time.

6. The apparatus of claim 1, wherein the at least one processor is configured to:
during the second period of time, identify that a WWAN upload is required, interrupt the communication of the RFID signals, reconfigure the antenna to communicate the WWAN signals; and
cause the antenna to transmit WWAN communications to the network entity.

7. The apparatus of claim 6, wherein the WWAN upload is responsive to an aperiodic CSI, aperiodic CQI, a SRS, or a HARQ feedback.

8. The apparatus of claim 1, wherein the at least one processor is configured to repeat operations of the first period of time with a periodicity corresponding to required communications for a voice call.

9. The apparatus of claim 1, wherein the at least one processor is configured to repeat operations of the first period of time with a periodicity corresponding to a periodicity of one or more video frames of a video signal.

10. An apparatus for wireless communications, comprising:
at least one memory; and
at least one processor coupled to the at least one memory, the at least one processor configured to:
configure a first antenna and a second antenna to communicate Wireless Wide Area Network (WWAN) signals;
establish a WWAN session with a network entity;
during a first period of time corresponding to one or more first slots of a WWAN frame, cause the first antenna to communicate one or more first WWAN signals with the network entity;
reconfigure the first antenna to communicate Radio Frequency Identification (RFID) signals; and
during a second period of time corresponding to one or more second slots of the WWAN frame, cause the first antenna to emit an RFID communication and cause the second antenna to communicate one or more second WWAN signals with the network entity.

11. The apparatus of claim 10, wherein the WWAN frame comprises a duration of 10 milliseconds (ms) and each slot of the one or more first slots comprises a duration of 1 ms.

12. The apparatus of claim 10, wherein the one or more first slots comprise six slots and the one or more second slots comprise four slots or the one or more first slots comprise five slots and the one or more second slots comprise five slots.

13. The apparatus of claim 10, wherein the WWAN frame is a Long Term Evolution (LTE) frame.

14. The apparatus of claim 10, wherein the WWAN frame is a Fifth Generation (5G) frame.

15. The apparatus of claim 10, wherein one or more second slots of the WWAN frame are scheduled for downlink WWAN data and/or WWAN signaling.

16. The apparatus of claim 10, wherein one or more second slots of the WWAN frame are scheduled for uplink WWAN data and/or WWAN signaling.

17. The apparatus of claim 10, wherein the first period of time corresponds to a periodicity of required communications for a voice call packet or a periodicity of required communications for a video call packet.

18. The apparatus of claim 10, wherein the WWAN frame is a Time Division (TDD) Duplex frame.

19. The apparatus of claim 10, wherein:
to communicate the one or more first WWAN signals, the first antenna is configured to transmit the one or more first WWAN signals to the network entity; and
to communicate the one or more second WWAN signals, the second antenna is configured to receive the one or more second WWAN signals from the network entity.

20. An apparatus for wireless communications, comprising:
at least one memory; and
at least one processor coupled to the at least one memory, the at least one processor configured to:
configure a first antenna and a second antenna to communicate Wireless Wide Area Network (WWAN) signals;
establish a WWAN session with a network entity; and
during a first period of time of the WWAN session, cause the first antenna to communicate first WWAN data with the network entity, cause the second antenna to communicate second WWAN data with the network entity, reconfigure the second antenna to communicate Radio Frequency Identification (RFID) signals, and cause the second antenna to communicate an RFID signal.
